(19) United States
(12) Patent Application Publication
(10) Pub. No.: US 2023/0272185 A1
(43) Pub. Date: Aug. 31, 2023

(54) ADDITIVES FOR FLAME RETARDED POLYOLEFINS

(71) Applicant: Albemarle Corporation, Charlotte, NC (US)

(72) Inventors: Jonathan P. McCarney, Baton Rouge, LA (US); Daniel A. De Schryver, Bonheiden (BE); Rajeev S. Mathur, Baton Rouge, LA (US)

(21) Appl. No.: 18/019,311

(22) PCT Filed: Aug. 5, 2021
(86) PCT No.: PCT/US2021/044682

§ 371 Date: Feb. 2, 2023

Related U.S. Application Data
(60) Provisional application No. 63/062,559, filed on Aug. 7, 2020.

(51) Int. Cl. C08K 5/03; C08K 5/52; C08K 3/34; C08L 23/12

(52) U.S. Cl. CPC C08K 5/03; C08K 5/5205; C08K 3/34; C08L 23/12; C08K 2201/005

(57) ABSTRACT

This invention provides a flame retardant additive composition which comprises at least one glow suppressant and at least one brominated flame retardant. The glow suppressant is about 0.5 wt % or more of the flame retardant additive composition, based on the total weight of the flame retardant additive composition. The brominated flame retardant contains aromatically-bound bromine and is selected from a) a brominated anionic styrenic polymer having a number average molecular weight of about 750 to about 7500, and/or a bromine content of about 60 wt % to about 77 wt %, b) a brominated anionic chain transfer vinyl aromatic polymer which contains about 70 wt % or more bromine, or a mixture of any two or more of these. Also provided are flame retarded polyolefin compositions that contain at least one glow suppressant and a brominated flame retardant.

### TECHNICAL FIELD

This invention relates to flame retardant additive compositions and to flame retarded polyolefins.

### BACKGROUND

Many plastics are flame retarded to minimize the spread of fire, including polyolefins. In WO 2005/095685, polybrominated anionic styrenic polymers are used to flame retard polyolefins, in conjunction with at least one synergist; the polybrominated anionic styrenic polymer is no more than about 15 wt % of the polyolefin. WO 2001/029124 discloses polyolefins with flame retardants, which include the bis(2,3-dibromopropyl ether) of tetrabromobisphenol-A and the bis(2,3-dibromopropyl ether) of tetrabromobisphenol-S. In U.S. Pat. No. 6,780,348, combinations of a polybromodiphenylalkane and a tetrabromobisphenol-A-bis(bromoalkyl ether) are disclosed. U.S. Pat. Nos. 8,476,373 and 8,933,159 are directed to brominated anionic chain transfer vinyl aromatic polymers, which can flame retard polyolefins.

In polyolefins, a problem that often persists in a polyolefin containing a flame retardant after the flame is extinguished is glow (sometimes called afterglow). Long glow times are not acceptable in some applications.

The art continually looks for improved flame retardancy for plastics such as polyolefins.

### SUMMARY OF THE INVENTION

This invention provides flame retardant additive compositions and polyolefins containing flame retardant additive compositions. The flame retardants are brominated aromatic polymeric flame retardants. Polyolefins containing flame retardant additive compositions of this invention have good performance in the UL-94 vertical burn test.

An embodiment of this invention is a flame retarding mixture comprising at least one brominated flame retardant and at least one glow suppressant. The brominated flame retardant contains aromatically-bound bromine, and is a) a brominated anionic styrenic polymer having a number average molecular weight of about 750 to about 7500, and/or a bromine content of about 60 wt % to about 77 wt %, b) a brominated anionic chain transfer vinyl aromatic polymer which contains about 70 wt % or more bromine, or a mixture of any two or more of these.

Another embodiment of this invention is a flame retarded polyolefin composition formed from at least one polyolefin, at least one brominated flame retardant, at least one glow suppressant, and at least one inorganic compound. The brominated flame retardant contains aromatically-bound bromine, and is a) a brominated anionic styrenic polymer having a number average molecular weight of about 750 to about 7500, and/or a bromine content of about 60 wt % to about 77 wt %, b) a brominated anionic chain transfer vinyl aromatic polymer which contains about 70 wt % or more bromine, or a mixture of any two or more of these.

Still another embodiment of this invention is a flame retarded polyolefin composition formed from at least one polyolefin, at least one brominated flame retardant, and at least one inorganic compound. The brominated flame retardant contains aromatically-bound bromine, and is a brominated anionic styrenic polymer having a number average molecular weight of about 750 to about 7500, and/or a bromine content of about 60 wt % to about 77 wt %.

Other embodiments of the invention include processes for preparing the flame retardant additive compositions and flame retarded polyolefin compositions of the invention.

These and other embodiments and features of this invention will be still further apparent from the ensuing description and appended claims.

### FURTHER DETAILED DESCRIPTION OF THE INVENTION

Throughout this document, the flame retardant additive composition is sometimes referred to as an “additive composition.” The phrase “polyolefin composition” is sometimes used to refer to the flame retarded polyolefin compositions of the invention.

A brominated flame retardant that can be used in the practice of this invention is a low molecular weight brominated anionic styrenic polymer having a number average molecular weight (Mₙ) of about 750 or more, preferably about 1000 or more, more preferably about 2000 or more. In some embodiments, these brominated anionic styrenic polymers have an Mₙ in the range of about 750 to about 7500, preferably about 1000 to about 4000, and more preferably about 2000 to about 3500.

Typically, the low molecular weight brominated anionic styrenic polymers contain about 60 wt % or more bromine, preferably about 66 wt % or more bromine, more preferably about 72 wt % or more bromine. In some embodiments, these brominated anionic styrenic polymers contain about 60 wt % to about 77 wt % bromine, preferably about 66 wt % to about 77 wt %, more preferably about 72 wt % to about 76 wt % bromine.

Preferably, the low molecular weight brominated anionic styrenic polymers are brominated anionic polystyrenes. In some embodiments, the low molecular weight brominated anionic styrenic polymers are brominated anionic polystyrenes having a number average molecular weight of about 750 to about 7500, and about 60 wt % to about 77 wt % bromine, preferably a number average molecular weight of about 1000 to about 4000, and about 70 wt % to about 77 wt % bromine, more preferably a number average molecular weight of about 2000 to about 3500, and about 72 wt % to about 76 wt % bromine.

The low molecular weight brominated anionic styrenic polymers can be formed by bromination in an organic solvent. Information on the preparation of low molecular weight brominated anionic styrenic polymers is found for example in International Patent Publications WO 2017/176740 and WO 2017/184350.

Another brominated flame retardant that can be used in the practice of this invention is sometimes not categorized as a styrenic polymer due to the relatively small number of repeating units in these molecules. These molecules contain aromatically-bound bromine and styrenic repeating units. This brominated flame retardant is a brominated anionic chain transfer vinyl aromatic polymer which contains about 70 wt % or more bromine, preferably about 72 wt % or more bromine, and a number average molecular weight of about 1000 or more, preferably about 1250 or more. In some embodiments, the bromine content is in the range of about 70 wt % to about 79 wt %, preferably about 72 wt % to about 78 wt %, and the Mₙ is in the range of about 1000 to about 21,000, preferably about 1250 to about 14,000, more preferably about 2000 to about 10,000.

Preferably, the brominated anionic chain transfer vinyl aromatic polymers are brominated anionic chain transfer polystyrenes. In some embodiments, the brominated anionic chain transfer vinyl aromatic polymers are brominated anionic chain transfer polystyrenes having a number average molecular weight of about 2000 to about 10,000, and about 72 wt % to about 78 wt % bromine.

The brominated anionic chain transfer vinyl aromatic polymers can be formed by bromination in an organic solvent or in a sea of bromine (in which bromine is both the brominating agent and the solvent). Information on the preparation of brominated anionic chain transfer vinyl aromatic polymers is found for example in U.S. Pat. Nos. 8,420,876, 8,796,388, and 8,993,684.

### Flame Retardant Additive Compositions

As noted above, the flame retardant additive compositions of the invention comprise at least one brominated flame retardant and at least one glow suppressant.

In the flame retardant additive compositions of the invention, the bulk of the composition is comprised of the brominated flame retardant. The additive compositions are described in terms of the other ingredients present in the composition, with the understanding that the remainder of the composition is made up of the brominated flame retardant. The brominated flame retardant contains aromatically-bound bromine, and is a) a brominated anionic styrenic polymer having a number average molecular weight of about 750 to about 7500, and/or a bromine content of about 60 wt % to about 77 wt %, b) a brominated anionic chain transfer vinyl aromatic polymer which contains about 70 wt % or more bromine, or a mixture of any two or more of these.

Mixtures of two or more brominated flame retardants can be used in the practice of this invention. In addition to the brominated anionic styrenic polymers and/or brominated anionic chain transfer vinyl aromatic polymers, the flame retardant additive compositions can contain one or more other brominated flame retardants. Suitable brominated flame retardants include hexabromocyclohexane, dibromoethyldibromocyclohexane, monochloropentabromocyclohexane, tetrabromocyclooctane, hexabromocyclododecane, bis(pentabromophenyl)ethane (decabromodiphenyl ethane), hexabromobenzene, dibromostyrene and derivatives thereof, pentabromodiphenyl oxide, octabromodiphenyl oxide (octabromodiphenyl ether), decabromodiphenyl oxide (decabromodiphenyl ether), 1,2-bis(tribromophenoxy)ethane, tetradecabromodiphenoxybenzene, 2,4,6-tribromophenol allyl ether, dibromoneopentyl glycol, tribromoneopentyl alcohol, tetrabromobisphenol-A, tetrabromobisphenol A diallyl ether, tetrabromobisphenol-A bis(2,3-dibromopropyl ether), bis(2,4,6-tribromophenoxyethyl) tetrabromobisphenol-A ether, tetrabromobisphenol-bis(2-hydroxyethyl) ether, tetrabromobisphenol-S, tetrabromobisphenol-S bis(2,3-dibromopropyl ether), brominated epoxy oligomer, such as tribromophenol endcapped brominated epoxy oligomers, brominated carbonate oligomers based on tetrabromobisphenol-A such as 2,4,6-tribromophenyl terminated tetrabromobisphenol-A carbonate oligomer and phenoxy-terminated tetrabromobisphenol-A carbonate oligomer, brominated polystyrenes, block copolymers of polystyrene and brominated polybutadiene, poly(dibromophenylene oxide), poly(pentabromobenzyl acrylate), brominated phthalic acids, diallyl tetrabromophthalate, bis(2-ethylhexyl) tetrabromophthalate, tetrabromophthalimide, N,N-ethylene-bis(tetrabromophthalimide), tetrabromophthalic anhydride, a mixed ester of tetrabromophthalic anhydride with diethylene glycol and propylene glycol, N,N′-ethylene-bis-(5,6-dibromonorbornane 2,3-dicarboximide), tris(tribromophenyl)triazine, brominated phenoxytriazines such as tris(tribromophenoxy)triazine, brominated maleimides such as tribromophenyl maleimide, brominated trimethylphenylindan, brominated isocyanurates such as tris(2,3-dibromopropyl)isocyanurate, and tris(tribromoneopentyl) phosphate. Preferred brominated flame retardants to use in admixture with the brominated anionic styrenic polymers and/or brominated anionic chain transfer vinyl aromatic polymers include decabromodiphenyl ethane and N,N-ethylene-bis(tetrabromophthalimide).

The UL-94 vertical burn test defines afterglow time (glow time) as “the length of time during which an afterglow persists under specified conditions.” A glow suppressant is a substance that reduces the afterglow time. The glow suppressants in the practice of this invention are compounds comprising at least one 5-membered or 6-membered ring moiety containing at least one nitrogen atom. More than one type of nitrogen-containing ring can be present in the glow suppressant. The ring(s) containing the nitrogen atom(s) may be saturated or unsaturated; unsaturated rings are preferred. The nitrogen-containing ring moieties each typically have one, two, or three nitrogen atoms. Nitrogen-containing ring moieties having three nitrogen atoms are preferred in some embodiments. The glow suppressant molecules can contain nitrogen in an amount of about 2 wt % or more, about 5 wt % or more, or about 10 wt % or more.

The nitrogen-containing ring moieties include triazole, pyridine, pyridazine, pyrimidine, pyrazine, piperidine, piperazine, triazine, pyrrole, pyrazole, imidazole, morpholine, oxazole, and oxazine. Preferred nitrogen-containing ring moieties are triazole, piperidine, piperazine, triazine, and morpholine; more preferred are triazole, piperazine, and triazine. When the nitrogen-containing ring moiety is a triazine, it is preferably a 1,3,5-triazine, more preferably the 1,3,5-triazine is substituted at the 2, 4, and 6 positions of the ring; even more preferably, the substituents are amino groups. Some of the glow suppressants in the practice of this invention are organic compounds that typically contain a plurality of rings, with each ring having at least two nitrogen atoms in the ring; preferably, the rings are 6-membered rings. The ring moieties can have one or more substituents, which can be bound to the ring carbon atoms or bound to the ring nitrogen atom(s). Preferably, the substituents are hydrocarbyl or nitrogen-containing. When the substituent is nitrogen-containing, it is sometimes preferably an amino group.

In some preferred embodiments, the glow suppressants contain nitrogen in an amount of about 10 wt % or more in the molecule and also contain phosphorus in an amount of about 10 wt % or more in the molecule, with the nitrogen and phosphorus in a nitrogen:phosphorus ratio of about 0.4:1 to about 4:1 N:P on a weight basis. In these preferred embodiments, the glow suppressants preferably have a molecular weight in the range of about 125 g/mol to about 2765 g/mol. In some preferred embodiments, the glow suppressants have a molecular weight in the range of about 125 g/mol to about 700 g/mol.

Suitable glow suppressants include 1,3,5-triazine-2,4,6-triamine phosphate (often called melamine polyphosphate); melamine poly(zinc phosphate); poly-[2,4-(piperazine-1,4-yl)-6-(morpholine-4-yl)-1,3,5-triazine; a mixture of 2,5,8-triamino-1,3,4,6,7,9,9b-heptaazaphenalene and 2,2′-iminobis(4,6-diamino-1,3,5-triazine); a mixture of 55 to 65% piperazine pyrophosphate and 35 to 45% phosphoric acid compound; a mixture of ammonium polyphosphate and poly-[2,4-(piperazine-1,4-yl)-6-(morpholine-4-yl)-1,3,5-triazine; a mixture of ammonium polyphosphate, a carbon booster, and poly-[2,4-(piperazine-1,4-yl)-6-(morpholine-4-yl)-1,3,5-triazine; a mixture of 2,5,8-triamino-1,3,4,6,7,9,9b-heptaazaphenalene and 2,2′-iminobis(4,6-diamino-1,3,5-triazine; piperazine pyrophosphate; 2,2′-methylenebis(6-2H-benzotriazol-2-yl)-4-(1,1,3,3-tetramethylbutyl)phenol; 2-(2-hydroxy-5-methylphenyl)benzotriazole; 2-(4,6-diphenyl-1,3,5-triazin-2-yl)-5-[2-(2-ethylhexanoyloxy)ethoxy]phenol; 1,2,3,4-butanetetracarboxylic acid polymer with 2,2-bis(hydroxymethyl)-1.3-propanediol and 3-hydroxy-2,2-dimethylpropanal, 1,2,2,6,6,-pentamethyl-4-piperidinyl ester; 1,10-bis(2,2,6,6,-tetramethyl-4-piperidinyl) decanedioate; and bis(1-undecanoxy-2,2,6,6 tetramethyl-4-piperidinyl) carbonate. Mixtures of two or more glow suppressants can be used if desired. Preferred glow suppressants include melamine polyphosphate and a mixture of aluminum diethyl phosphinate, melamine polyphosphate, and zinc borate. The effectiveness of any particular glow suppressant is affected by the brominated flame retardant and other components present in the composition.

The glow suppressant is usually in an amount of about 0.5 wt % or more, preferably 1 wt % or more, more preferably about 2 wt % or more, or about 0.5 wt % to about 15 wt %, preferably about 1 wt % to about 12 wt %, more preferably about 2 wt % to about 8 wt %, based on the total weight of the flame retardant additive composition, especially when the glow suppressant and the brominated flame retardant are the only components in the flame retardant additive composition. In other embodiments, especially when the glow suppressant and the brominated flame retardant are the only components in the flame retardant additive composition, the glow suppressant is preferably about 10 wt % to about 30 wt %, more preferably about 15 wt % to about 30 wt %, based on the total weight of the additive composition.

When the glow suppressant is poly-[2,4-(piperazine-1,4-yl)-6-(morpholine-4-yl)-1,3,5-triazine and/or piperazine polyphosphate, the amount of glow suppressant is preferably about 1.5 wt % or more.

When one or more components in addition to the glow suppressant and the brominated flame retardant are present in the flame retardant additive composition, the glow suppressant is typically about 0.5 wt % or more, preferably about 1 wt % or more, more preferably about 1.3 wt % or more, based on the total weight of the additive composition. In some embodiments, the glow suppressant is about 0.5 wt % to about 20 wt %, preferably about 1 wt % to about 17 wt %, more preferably about 1.3 wt % to about 16 wt %, based on the total weight of the additive composition.

Optional ingredients that can be present are often present in the flame retardant additive compositions include inorganic compounds, antioxidants, impact modifiers, compatibilizers, halogenated polyethlyenes, pigments, flame retardant synergists, anti-dripping agents, dyes, light stabilizers, UV stabilizers, fillers, antifoaming agents, antimicrobial agents, biocidal agents, buffers, pH stabilizers, fixing agents, anti-static agents, soil repellants, wetting agents, softeners, water repellants, optical brighteners, plasticizers, emulsifiers, acid scavengers, radical scavengers, metal scavengers or deactivators, processing aids, mold release agents, lubricants, anti-blocking agents, antistatic agents, slip additives, blowing agents, antifogging agents, reinforcing agents, coupling agent, nucleating agents, other flame retardants, and other thermal stabilizers.

Preferred optional ingredients include inorganic compounds, antioxidants, impact modifiers, compatibilizers, halogenated polyethlyenes, and pigments. In some preferred embodiments, one or more antioxidants, one or more compatibilizers, one or more impact modifiers, one or more halogenated polyethlyenes, and/or one or more pigments are present in the additive composition. In some preferred embodiments, at least one inorganic compound and one or more other optional ingredients selected from antioxidants, impact modifiers, compatibilizers, and halogenated polyethlyenes are present in the flame retardant additive composition.

Inorganic compounds are a preferred type of optional ingredient. As used throughout this document, the phrase “inorganic component” refers to one or more inorganic compounds which contain one or more metal atoms that do not have a hydrocarbyl group bound directly to the metal atom(s). More preferably, at least one inorganic compound is present in the flame retardant additive composition.

The inorganic compounds grouped together here are often classified separately, as flame retardant synergists, fillers, pigments, and so forth. The presence of one or more inorganic compounds has sometimes been observed to have a beneficial effect on the afterflame time (burn time) and/or glow time when tested in a flame retarded polyolefin composition. Afterflame time is defined in the UL-94 vertical burn test as the time during which the material continues to flame after the ignition source has been removed. As noted above, afterglow time, or glow time, is defined in the UL-94 vertical burn test as “the length of time during which an afterglow persists under specified conditions,” and afterglow, or glow, is defined in the UL-94 vertical burn test as “persistence of glowing combustion after both removal of the ignition source and the cessation of any flaming.”

Suitable inorganic compounds in the practice of this invention include talc, ammonium phosphate, ammonium phosphinate, antimony trioxide, antimony pentoxide, antimony phosphate, aluminum phosphinate, aluminum diethyl phosphinate, sodium antimonate, calcium stearate, calcium borate, calcium phosphinate, magnesium hydroxide, magnesium aluminum hydroxide carbonate, zinc borate, zinc oxide, zinc stannate, zinc sulfide, zinc phosphate, zinc phosphinate, zinc diethyl phosphinate, zinc molybdate, tin(IV) oxide, titanium dioxide, titanium phosphate, α-zirconium phosphate, wollastonite, hydrotalcite, silane-modified aluminum silicate, glass fibers, and clays including smectites such as montmorillonite, bentonite, nontronite, hectorite, laponite, beidellite, volkonskoite, sauconite, stevensite, and saponite; kaolins such as halloysite; micas such as ledikite; rectorite; tarasovite; kenyaite; permutite; vermiculites; attapulgites; and illites. Mixtures of two or more inorganic compounds can be used if desired, and in some embodiments, more than one inorganic compound is preferred.

Preferred inorganic compounds include talc, antimony trioxide, zinc borate, aluminum phophinate, aluminum diethyl phosphinate, calcium phosphinate, and hydrotalcite, and combinations of talc and antimony trioxide. The combinations of talc and antimony trioxide can be the only inorganic compounds, or one or more other inorganic compounds can also be present in the additive composition. In some preferred embodiments, the inorganic compounds are a combination of talc and antimony trioxide and at least one inorganic compound selected from zinc borate, aluminum phosphinate, aluminum diethyl phosphinate, calcium phosphinate, and/or hydrotalcite.

When present in the flame retardant additive composition, the inorganic compound is about 10 wt % or more, preferably about 15 wt % or more, more preferably about 25 wt % or more, or about 10 wt % to about 70 wt %, preferably about 15 wt % to about 60 wt %, more preferably about 15 wt % to about 60 wt %, based on the total weight of the additive composition. When more than one inorganic compound comprise the inorganic component of the additive composition, these values refer to the combined amount of inorganic compounds present in the additive composition.

When talc is present in the flame retardant additive composition, talc is about 10 wt % or more, preferably about 12 wt % or more, or about 10 wt % to about 50 wt %, preferably about 12 wt % to about 45 wt %, more preferably about 12 wt % to about 40 wt %, based on the total weight of the additive composition. When antimony trioxide is present in the flame retardant additive composition, antimony trioxide is about 2.0 wt % or more, preferably about 2.5 wt % or more, or about 2.0 wt % to about 35 wt %, preferably about 2.5 wt % to about 25 wt %, based on the total weight of the additive composition. When zinc borate, aluminum phosphinate, aluminum diethyl phosphinate, and/or calcium phosphinate are present in the flame retardant additive composition, each is present in an amount of about 0.5 wt % to about 10 wt %, preferably about 0.7 wt % to about 9 wt %, based on the total weight of the additive composition. When hydrotalcite is present in the flame retardant additive composition, it is present in an amount of about 0.1 wt % to about 5 wt %, preferably about 0.1 wt % to about 1 wt %, based on the total weight of the additive composition.

Antioxidants that can be used in the practice of this invention include phenolic antioxidants, thioesters, aromatic amines, phosphonites, and phosphite antioxidants. Suitable antioxidants include 2,6-di-tert-butyl-4-methyl phenol, tetrakis(3-(4-hydroxy-3,5-di-tert-butylphenyl)propionyloxymethyl)methane, 1,3,5-tris(3,5-di-tert-butyl-4-hydroxybenzyl)-s-triazine-2,4,6(1H,3H,5H)trione, octadecyl 3,5-di-tert-butyl-4-hydroxyhydrocinnamate, 1,3,5-trimethyl-2,4,6-tris(3,5-di-tert-butyl-4-hydroxybenzyl)benzene, 4,4′-methylenebis(2,6-di-tert-butyl-phenol), ethylenebis(oxyethylene)bis-(3-(5-tert-butyl-4-hydroxy-m-tolyl)-propionate), N,N′-(hexane-1,6-diyl)bis(3-(3,5-di-tert-butyl-4-hydroxypheny100propionamide), hexadecyl-3,5-di-t-butyl-4-hydroxybenzoate, 2,2′-thiodiethylene bis[3-(3,5-di-tert-butyl-4-hydroxyphenyl)propinate], C₁₃-C₁₅ linear and branched alkyl esters of 3-(3′5′-di-t-butyl-4′-hydroxyphenyl)propionic acid, C₉-C₁₁ linear and branched alkyl esters of 3-(3′,5′-di-t-butyl-4′-hydroxyphenyl)propionic acid, 2,2′-methylenebis(6-tert-butyl-4-methylphenol), 2,2′-ethylidenebis(4,6-di-tert-butylphenol), (1,1-di-tert-butyl)-4-hydroxyphenyl)methyl)ethylphosphonate, N-phenyl-benzenamine reaction products with 2,4,4-trimethylpentene, dimyristyl thiodipropionate, distearyldisulfide, pentaerythritol tetrakis(β-laurylthiopropionate), dioctadecyl 3,3′-thiodipropanoate, didodecyl 3,3′-thiodipropanoate, tris-(2,4-di-tert-butylphenyl)phosphite, bis(2,4-di-tert-butylphenyl)pentraerythritol diphosphate, (2,4,6-tri-tert-butylphenyl)(2-butyl-2-ethyl-1,3-propanediol) phosphite, tetrakis(2,4-di-tert-butylphenyl)-4,4′-biphenylene diphosphonite, distearylpentaerythritol diphosphite, bis(2,4-dicumylphenyl) pentaerythritol diphosphate, tris(dipropyleneglycol) phosphite, poly(dipropylene glycol) phenyl phosphite, diphenyl isodecyl phosphite, phenyl diisodecyl phosphite, heptakis(dipropyleneglycol) triphosphate, tris(nonylphenyl) phosphite, bis(2,6-di-tert-butyl-4-methylphenyl)pentaerythritol diphosphite, 2,2′-ethylidenebis(4,6-di-tert-butylphenyl) fluorophosphonite, 2,2′-methylenebis(4,6-di-tert-butylphenyl)octyl-phosphite, trilauryl trithiophosphite, 1,2-bis(3,5-di-tert-butyl-4-hydroxyhydrocinnamoyl)hydrazine, and 1:1:2 combination of calcium (3,5-di-tert-butyl-4-hydroxyphenyl)methyl ethoxyphosphinate, polyethylene wax and tris(2,4-di-tert-butylphenyl) phosphite. Mixtures of two or more antioxidants can be used. Preferred antioxidants include tetrakis(3-(4-hydroxy-3,5-di-tert-butylphenyl)propionyloxymethyl)methane and tris-(2,4-di-tert-butylphenyl) phosphite; more preferred is a combination of tetrakis(3-(4-hydroxy-3,5-di-tert-butylphenyl)propionyloxymethyl)methane and tris-(2,4-di-tert-butylphenyl) phosphite.

The antioxidant is about 0.1 wt % or more, preferably about 0.2 wt % or more, or about 0.1 wt % to about 2 wt %, preferably about 0.2 wt % to about 1 wt %, based on the total weight of the additive composition. When more than one antioxidant is present in the additive composition, these values refer to the combined amount of antioxidants present in the additive composition.

Generally, impact modifiers are rubbers or elastomers. Suitable impact modifiers in the practice of this invention include ethylene octene copolymers and ethylene hexene copolymers. Ethylene octene copolymers are preferred impact modifiers in the practice of this invention. Mixtures of impact modifiers can be used if desired.

Impact modifiers are typically about 1 wt % or more, preferably about 3 wt % or more, or about 1 wt % to about 40 wt %, preferably about 3 wt % to about 30 wt %, more preferably about 7 wt % to about 20 wt %, based on the total weight of the additive composition. When more than one impact modifier is present in the additive composition, these values refer to the combined amount of impact modifiers present in the additive composition.

Compatibilizers are sometimes thermoplastic elastomers, maleated copolymers of olefin homopolymers or copolymers, or in situ-formed macromolecule catalysts. Compatibilizers suitable for use in the practice of this invention include styrene ethylene butadiene copolymers, especially styrene ethylene/butylene linear triblock copolymers, maleic anhydride modified polypropylene homopolymers, and a sodium ionomer of ethylene/methacrylic acid copolymer. Mixtures of compatibilizers can be used. Preferred compatibilizers include styrene ethylene/butylene linear triblock copolymers.

In the flame retardant additive compositions, compatibilizers are often in an amount of 0.5 wt % or more, preferably about 3 wt % or more, or about 0.5 wt % to about 40 wt %, preferably about 3 wt % to about 30 wt %, more preferably about 3 wt % to about 20 wt %, based on the total weight of the additive composition. When more than one compatibilizer is present in the additive composition, these values refer to the combined amount of compatibilizers present in the additive composition.

Halogenated polyethylenes are polyethylenes containing halogen atoms. Suitable halogenated polyethlyenes include polytetrafluoroethylene and chlorinated polyethylene. Mixtures of halogenated polyethylenes can be used.

The halogenated polyethylene is about 0.1 wt % or more, preferably about 0.2 wt % or more, more preferably about 0.5 wt % or more, based on the total weight of the additive composition. In some embodiments, the halogenated polyethylene is about 0.1 wt % to about 10 wt %, preferably about 0.2 wt % to about 5 wt %, more preferably about 0.5 wt % to about 3 wt %, based on the total weight of the additive composition. When more than one halogenated polyethylene is present in the flame retardant additive composition, these values refer to the combined amount of halogenated polyethylenes present in the flame retardant additive composition.

Pigments are substances that impart coloration to a polymer, especially to a polyolefin, and are generally used only when a color for the polyolefin composition is desired. Suitable pigments in the practice of this invention include a mixed oxide of chromium, antimony, and titanium (Brown 24), a mixed compound of chromium, nickel, and titanium (Yellow 53), 1,8-bis(phenylthio)anthracene-9,10-dione (Solvent Yellow 163), titanium dioxide, and carbon black. Mixtures of two or more pigments can be used.

The pigment is about 30 wt % or less, preferably about 20 wt % or less, more preferably about 10 wt % or less, or about 0 wt % to about 30 wt %, preferably about 0 wt % to about 20 wt %, more preferably about 0 wt % to about 10 wt %, based on the total weight of the additive composition. When more than one pigment is present in the flame retardant additive composition, these values refer to the combined amount of pigments present in the flame retardant additive composition.

In some preferred embodiments, the glow suppressant is melamine polyphosphate, and the inorganic compounds include zinc borate and aluminum diethyl phosphinate. More preferably, when the glow suppressant is melamine polyphosphate, and the inorganic compounds include zinc borate and aluminum diethyl phosphinate, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the melamine polyphosphate is about 2 wt % to about 5 wt %, based on the total weight of the flame retardant additive composition; the total amount of inorganic compounds is about 25 wt % to about 60 wt %, based on the total weight of the flame retardant additive composition; more preferably, talc and antimony trioxide are also present in the composition.

In some preferred embodiments, the glow suppressant is melamine polyphosphate, and the inorganic compounds include talc and antimony trioxide. More preferably, when the glow suppressant is melamine polyphosphate, and the inorganic compounds include talc and antimony trioxide, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the melamine polyphosphate is about 2 wt % to about 5 wt %, based on the total weight of the flame retardant additive composition; and the total amount of inorganic compounds is about 25 wt % to about 60 wt %, based on the total weight of the flame retardant additive composition. Preferably, at least one phenolic antioxidant is present in the composition. More preferably, chlorinated polyethylene and/or polytetrafluoroethylene are also present, each being in an amount of about 0.2 wt % to about 5 wt %.

In another preferred embodiment, the glow suppressant is melamine polyphosphate, and inorganic compounds which include antimony trioxide and talc, and an impact modifier, preferably an ethylene octene copolymer, are present, more preferably both chlorinated polyethylene and polytetrafluoroethylene are also present, the chlorinated polyethylene and the polytetrafluoroethylene each being in an amount of about 0.2 wt % to about 5 wt %, based on the total weight of the flame retardant additive composition. The ethylene octene copolymer is preferably about 3 wt % to about 30 wt %, based on total weight of flame retardant additive composition. More preferably, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the melamine polyphosphate is about 1.25 wt % to about 5 wt %, based on the total weight of the flame retardant additive composition; the total amount of inorganic compounds is about 25 wt % to about 60 wt %, based on the total weight of the flame retardant additive composition. Preferably, at least one phenolic antioxidant is also present in the flame retardant additive composition.

In still another preferred embodiment, the glow suppressant is melamine polyphosphate, and inorganic compounds which include antimony trioxide and talc, and an impact modifier, preferably an ethylene octene copolymer, are present, more preferably both chlorinated polyethylene and polytetrafluoroethylene are also present, the chlorinated polyethylene and the polytetrafluoroethylene each being in an amount of about 0.2 wt % to about 5 wt %, based on the total weight of the flame retardant additive composition. The ethylene octene copolymer is preferably about 3 wt % to about 30 wt %, based on total weight of flame retardant additive composition. More preferably, the brominated flame retardant is comprised of a) brominated anionic styrenic polymer having a number average molecular weight of about 1000 to about 4000, and about 70 wt % to about 77 wt % bromine, even more preferably about 72 wt % to about 76 wt % bromine and b) decabromodiphenylethane or N,N-ethylene-bis(tetrabromophthalimide. In these preferred embodiments, the melamine polyphosphate is about 1.25 wt % to about 5 wt %, based on the total weight of the flame retardant additive composition; the total amount of inorganic compounds is about 25 wt % to about 60 wt %, based on the total weight of the flame retardant additive composition. Preferably, at least one phenolic antioxidant is also present in the flame retardant additive composition.

In yet another preferred embodiment, the glow suppressant is a mixture of aluminum diethyl phosphinate, melamine polyphosphate, and zinc borate, and inorganic compounds which include antimony trioxide, and an impact modifier, preferably an ethylene octene copolymer, are present, more preferably both chlorinated polyethylene and polytetrafluoroethylene are also present, the chlorinated polyethylene and the polytetrafluoroethylene each being in an amount of about 0.2 wt % to about 5 wt %, based on the total weight of the flame retardant additive composition. The ethylene octene copolymer is preferably about 3 wt % to about 30 wt %, based on total weight of flame retardant additive composition. More preferably, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the mixture of aluminum diethyl phosphinate, melamine polyphosphate, and zinc borate is about 2 wt % to about 10 wt %, based on the total weight of the flame retardant additive composition; the total amount of inorganic compounds is about 10 wt % to about 25 wt %, based on the total weight of the flame retardant additive composition. Preferably, at least one phenolic antioxidant is also present in the flame retardant additive composition.

In still another preferred embodiment, the glow suppressant is melamine polyphosphate, and inorganic compounds which include antimony trioxide and talc, and a compatibilizer, preferably a styrene ethylene/butylene linear triblock copolymer, are present, more preferably polytetrafluoroethylene is also present, the polytetrafluoroethylene being in an amount of about 0.2 wt % to about 5 wt %, based on the total weight of the flame retardant additive composition. The styrene ethylene/butylene linear triblock copolymer is preferably about 3 wt % to about 30 wt %, based on total weight of flame retardant additive composition. More preferably, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the melamine polyphosphate is about 2 wt % to about 5 wt %, based on the total weight of the flame retardant additive composition; the total amount of inorganic compounds is about 25 wt % to about 60 wt %, based on the total weight of the flame retardant additive composition. Preferably, at least one phenolic antioxidant is also present in the flame retardant additive composition.

In another preferred embodiment, the glow suppressant is a mixture of aluminum diethyl phosphinate, melamine polyphosphate, and zinc borate, and inorganic compounds including antimony trioxide, and a compatibilizer, preferably a styrene ethylene/butylene linear triblock copolymer, are present, more preferably both chlorinated polyethylene and polytetrafluoroethylene are also present, the chlorinated polyethylene and the polytetrafluoroethylene each being in an amount of about 0.2 wt % to about 5 wt %, based on the total weight of the flame retardant additive composition. The styrene ethylene/butylene linear triblock copolymer is preferably about 3 wt % to about 30 wt %, based on total weight of flame retardant additive composition. More preferably, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the glow suppressant is about 2 wt % to about 10 wt %, based on the total weight of the flame retardant additive composition; the total amount of inorganic compounds is about 5 wt % to about 25 wt %, based on the total weight of the flame retardant additive composition. Preferably, at least one phenolic antioxidant is also present in the flame retardant additive composition.

### Processes for Forming Flame Retardant Additive Compositions

Processes of the invention for forming the flame retardant additive compositions of the invention comprise combining at least one brominated flame retardant and at least one glow suppressant. The amount of glow suppressant is usually about 0.5 wt % or more, based on the total weight of the additive composition. The brominated flame retardant contains aromatically-bound bromine and is a) a brominated anionic styrenic polymer having a number average molecular weight of about 750 to about 7500, and/or a bromine content of about 60 wt % to about 77 wt %, b) a brominated anionic chain transfer vinyl aromatic polymer which contains about 70 wt % or more bromine, or a mixture of any two or more of these.

The components of the flame retardant additive composition can be combined in any order. For example, the brominated flame retardant and the glow suppressant can be combined, followed by combining components such as at least one inorganic compound. Alternatively, the glow suppressant and one or more other components such as at least one inorganic compound can be mixed together and then combined with the brominated flame retardant. Another way involves combining all of the components at the same time.

Most or all of the components of the flame retardant additive composition are dry solids, and can be combined via various dry-blending techniques. If desired, the dry-blended mixture of components can be melted together. One or more of the components may instead be melted together without prior dry-blending. Components can be blended or mixed in portion as desired.

The brominated flame retardants and preferences therefor, as well as amounts and preferred amounts thereof, are as described above for the flame retardant additive compositions.

The glow suppressant and preferences therefor, as well as amounts and preferred amounts, are as described above for the flame retardant additive compositions.

Optional ingredients that can be introduced during preparation of the flame retardant additive composition, preferences therefor, and amounts and preferences therefor, are as described above for the flame retardant additive compositions.

### Flame Retarded Polyolefin Compositions

A flame retarded polyolefin composition of this invention comprises
i) at least one glow suppressant;
ii) at least one inorganic compound; and
iii) at least one brominated flame retardant in a flame retardant amount, wherein the brominated flame retardant contains aromatically-bound bromine and is selected from
   a) a brominated anionic styrenic polymer having a number average molecular weight of about 750 to about 7500, and/or a bromine content of about 60 wt % to about 77 wt %,
   b) a brominated anionic chain transfer vinyl aromatic polymer which contains about 70 wt % or more bromine, or a mixture of any two or more of these; and
iv) at least one polyolefin.
   The flame retarded polyolefin composition contains about 0.25 wt % or more glow suppressant, based on the total weight of the flame retarded polyolefin composition, and the flame retarded polyolefin composition contains about 5 wt % or more of inorganic compounds, based on the total weight of the flame retarded polyolefin composition.

Optional ingredients that are often present in the flame retarded polyolefin compositions are as described above for the flame retardant additive composition.

Suitable polyolefins in the practice of this invention include polyethylenes such as high density polyethylene (HDPE), low density polyethylene (LDPE), and linear low density polyethylene (LLDPE); polypropylene; copolymers formed from propylene and ethylene, including ethylene propylene diene polymers (EPDM); ethylene and/or propylene copolymers with other olefinic monomers copolymerizable therewith. Preferred polyolefins include polyethylene, polypropylene, and copolymers formed from propylene and ethylene. Mixtures of polyolefins can be used if desired.

The glow suppressants and preferences therefor are as described above. The amount of glow suppressant in the flame retarded polyolefin composition is usually about 0.25 wt % or more, preferably about 0.5 wt % or more, or about 0.25 wt % to about 15 wt %, preferably about 0.5 wt % to about 12 wt % glow suppressant, more preferably about 0.75 wt % to about 7.5 wt %, even more preferably about 0.5 wt % to about 5 wt % glow suppressant, still more preferably about 1 wt % to about 3 wt %, based on the total weight of the flame retarded polyolefin composition.

The inorganic compounds and preferences therefor are as described above. The total amount of inorganic compounds is in an amount of about 5 wt % or more, preferably about 8 wt % or more, more preferably about 12 wt % or more, based on the total weight of the flame retarded polyolefin composition. In some embodiments, the total amount of inorganic compounds is typically in an amount of about 5 wt % to about 35 wt %, preferably about 8 wt % to about 28 wt %, more preferably about 12 wt % to about 28 wt %, based on the total weight of the flame retarded polyolefin composition. When the amount of inorganic compound is less than about 10 wt %, the polyolefin composition may pass some flammability tests, such as the V-2 standard in the UL-94 vertical burn test, but it is often preferred that the polyolefin composition meet a more rigorous standard, such as V-0 in the UL-94 vertical burn test, for which a higher amount of brominated flame retardant is usually needed.

When talc is present in the flame retarded polyolefin composition, talc is about 10 wt % or more, preferably about 12 wt % or more, or about 10 wt % to about 40 wt %, preferably about 12 wt % to about 35 wt %, more preferably about 12 wt % to about 30 wt %, based on the total weight of the polyolefin composition. When antimony trioxide is present in the flame retarded polyolefin composition, antimony trioxide is about 1.5 wt % or more, preferably about 2 wt % or more, or about 1.5 wt % to about 20 wt %, preferably about 2 wt % to about 15 wt %, based on the total weight of the polyolefin composition. When zinc borate, aluminum phosphinate, aluminum diethyl phosphinate, and/or calcium phosphinate are present in the flame retarded polyolefin composition, each is present in an amount of about 0.25 wt % to about 10 wt %, preferably about 0.75 wt % to about 5 wt %, based on the total weight of the polyolefin composition. When hydrotalcite is present in the flame retarded polyolefin composition, it is present in an amount of about 0.1 wt % to about 5 wt %, preferably about 0.2 wt % to about 1 wt %, based on the total weight of the polyolefin composition.

In some preferred embodiments, the brominated flame retardant is a brominated anionic chain transfer vinyl aromatic polymer, more than one inorganic compound is present, and one of the inorganic compounds is antimony trioxide, and the total amount of inorganic compounds in the flame retarded polyolefin composition is preferably in an amount of about 2 wt % to about 25 wt %, based on the total weight of the flame retarded polyolefin composition.

Features of the brominated flame retardants and preferences therefor are as described above for the flame retardant additive composition. In the flame retarded polyolefin composition, the flame retardant amount is usually about 15 wt % or more, preferably about 20 wt % or more, more preferably about 24 wt % or more, based on total weight of flame retarded polyolefin composition. In some embodiments, the flame retardant amount is about 15 wt % to about 37 wt %, preferably about 20 to about 34 wt %, more preferably about 24 to about 28 wt %, based on total weight of flame retarded polyolefin composition.

In terms of bromine content, the flame retarded polyolefin composition preferably contains the brominated flame retardant in an amount to provide about 5 wt % bromine or more, more preferably about 10 wt % bromine or more, even more preferably about 15 wt % bromine or more, based on the total weight of the flame retarded polyolefin composition. In some embodiments, the brominated flame retardant is in an amount to provide about 5 wt % to about 30 wt % bromine, preferably about 10 wt % to about 25 wt % bromine, more preferably about 15 wt % to about 23 wt % bromine, based on the total weight of the flame retarded polyolefin composition. When more than one brominated flame retardant is present in the flame retarded polyolefin composition, these values refer to the combined amount of bromine present in the flame retarded polyolefin composition.

Antioxidants and preferences therefor are as described above. The amount of antioxidant is about 0.05 wt % or more, preferably about 0.1 wt % or more, or about 0.05 wt % to about 1 wt %, preferably about 0.1 wt % to about 0.5 wt %, based on the total weight of the flame retarded polyolefin composition. When more than one antioxidant is present in the flame retarded polyolefin composition, these values refer to the combined amount of antioxidants present in the flame retarded polyolefin composition.

Impact modifiers and preferences therefor are as described above, and are in an amount of about 0.5 wt % or more, preferably about 2 wt % or more, more preferably about 5 wt % or more, or about 0.5 wt % to about 20 wt %, preferably about 2 wt % to about 15 wt %, more preferably about 5 wt % to about 10 wt %, based on the total weight of the flame retarded polyolefin composition. When more than one impact modifier is present in the flame retarded polyolefin composition, these values refer to the combined amount of impact modifiers present in the flame retarded polyolefin composition.

Compatibilizers and preferences therefor are as described above, and are in an amount of about 0.25 wt % or more, preferably about 1 wt % or more, or about 0.5 wt % to about 20 wt %, preferably about 1 wt % to about 10 wt %, based on the total weight of the flame retarded polyolefin composition. When more than one compatibilizer is present in the flame retarded polyolefin composition, these values refer to the combined amount of compatibilizers present in the flame retarded polyolefin composition.

Halogenated polyethlyenes and preferences therefor are as described above, and are in an amount of about 0.05 wt % or more, preferably about 0.1 wt % or more, more preferably about 0.25 wt % or more, based on the total weight of the flame retarded polyolefin composition. In some embodiments, the halogenated polyethylene is about 0.05 wt % to about 5 wt %, preferably about 0.1 wt % to about 2.5 wt %, more preferably about 0.25 wt % to about 1.5 wt %, based on the total weight of the flame retarded polyolefin composition. When more than one halogenated polyethylene is present in the flame retarded polyolefin composition, these values refer to the combined amount of halogenated polyethylenes present in the flame retarded polyolefin composition.

Pigments and preferences therefor are as described above, and are in an amount of about 15 wt % or less, preferably about 10 wt % or less, more preferably about 5 wt % or less, or about 0 wt % to about 15 wt %, preferably about 0 wt % to about 10 wt %, more preferably about 0 wt % to about 5 wt %, based on the total weight of the flame retarded polyolefin composition. When more than one pigment is present in the flame retarded polyolefin composition, these values refer to the combined amount of pigments present in the flame retarded polyolefin composition.

In some preferred embodiments, the glow suppressant is melamine polyphosphate, and the inorganic compounds include zinc borate and aluminum diethyl phosphinate. More preferably, when the glow suppressant is melamine polyphosphate, and the inorganic compounds include zinc borate and aluminum diethyl phosphinate, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the brominated flame retardant is about 20 to about 30 wt %, more preferably about 24 to about 27 wt %, based on total weight of flame retarded polyolefin composition; the melamine polyphosphate is about 1 wt % to about 3 wt %, based on the total weight of the flame retarded polyolefin composition; the total amount of inorganic compounds is about 20 wt % to about 28 wt %, based on the total weight of the flame retarded polyolefin composition; more preferably, talc and antimony trioxide are also present in the composition.

In some preferred embodiments, the glow suppressant is melamine polyphosphate, and the inorganic compounds include talc and antimony trioxide. More preferably, when the glow suppressant is melamine polyphosphate and the inorganic compounds include talc and antimony trioxide, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the brominated flame retardant is about 20 to about 30 wt %, more preferably about 24 to about 27 wt %, based on total weight of flame retarded polyolefin composition; the melamine polyphosphate is about 1 wt % to about 3 wt %, based on the total weight of the flame retarded polyolefin composition; and the total amount of inorganic compounds is about 20 wt % to about 28 wt %, based on the total weight of the flame retarded polyolefin composition. Preferably, at least one phenolic antioxidant is present in the composition. More preferably, chlorinated polyethylene and/or polytetrafluoroethylene are also present, each being in an amount of about 0.25 wt % to about 1.5 wt %.

In another preferred embodiment in the polyolefin composition, an impact modifier, preferably an ethylene octene copolymer, is present, the glow suppressant is melamine polyphosphate, and the inorganic compounds include antimony trioxide and talc; more preferably both chlorinated polyethylene and polytetrafluoroethylene are also present. When present, the chlorinated polyethylene and the polytetrafluoroethylene are each in an amount of about 0.25 wt % to about 1.5 wt %, based on the total weight of the flame retarded polyolefin composition. In these preferred polyolefin compositions, the ethylene octene copolymer is preferably in an amount of about 2 wt % to about 15 wt %, based on total weight of flame retarded polyolefin composition. More preferably, when an impact modifier, preferably an ethylene octene copolymer, is present, the glow suppressant is melamine polyphosphate, and the inorganic compounds include antimony trioxide and talc, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the brominated flame retardant is about 20 to about 35 wt %, more preferably about 24 to about 30 wt %, based on total weight of flame retarded polyolefin composition; the melamine polyphosphate is about 0.75 wt % to about 3 wt %, based on the total weight of the flame retarded polyolefin composition; the total amount of inorganic compounds is about 8 wt % to about 28 wt %, based on the total weight of the flame retarded polyolefin composition. Preferably, at least one phenolic antioxidant is also present in the flame retarded polyolefin composition.

In still another preferred embodiment in the polyolefin composition, an impact modifier, preferably an ethylene octene copolymer, is present, the glow suppressant is melamine polyphosphate, and the inorganic compounds include antimony trioxide and talc; more preferably, both chlorinated polyethylene and polytetrafluoroethylene are also present. When present, the chlorinated polyethylene and the polytetrafluoroethylene are each in an amount of about 0.25 wt % to about 1.5 wt %, based on the total weight of the flame retarded polyolefin composition. In these preferred polyolefin compositions, the ethylene octene copolymer is preferably about 2 wt % to about 15 wt %, based on total weight of flame retarded polyolefin composition. More preferably, when an impact modifier, preferably an ethylene octene copolymer, is present, the glow suppressant is melamine polyphosphate, and the inorganic compounds include antimony trioxide and talc, the brominated flame retardant is comprised of a) brominated anionic styrenic polymer having a number average molecular weight of about 1000 to about 4000, and about 70 wt % to about 77 wt % bromine, even more preferably about 72 wt % to about 76 wt % bromine and b) decabromodiphenylethane or N,N-ethylene-bis(tetrabromophthalimide. In these preferred embodiments, the brominated flame retardant is about 20 to about 35 wt %, more preferably about 24 to about 30 wt %, based on total weight of flame retarded polyolefin composition; the melamine polyphosphate is about 0.75 wt % to about 3 wt %, based on the total weight of the flame retarded polyolefin composition; the total amount of inorganic compounds is about 8 wt % to about 28 wt %, based on the total weight of the flame retarded polyolefin composition. Preferably, at least one phenolic antioxidant is also present in the flame retarded polyolefin composition.

In yet another preferred embodiment in the polyolefin composition, an impact modifier, preferably an ethylene octene copolymer, is present, the glow suppressant is a mixture of aluminum diethyl phosphinate, melamine polyphosphate, and zinc borate, and the inorganic compounds include antimony trioxide; more preferably, both chlorinated polyethylene and polytetrafluoroethylene are also present. When present, the chlorinated polyethylene and the polytetrafluoroethylene are each in an amount of about 0.25 wt % to about 1.5 wt %, based on the total weight of the flame retarded polyolefin composition. In these preferred polyolefin compositions, the ethylene octene copolymer is preferably about 2 wt % to about 15 wt %, based on total weight of flame retarded polyolefin composition. More preferably, when an impact modifier, preferably an ethylene octene copolymer, is present, the glow suppressant is a mixture of aluminum diethyl phosphinate, melamine polyphosphate, and zinc borate, and the inorganic compounds include antimony trioxide, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the brominated flame retardant is about 20 to about 35 wt %, more preferably about 24 to about 34 wt %, based on total weight of flame retarded polyolefin composition; the glow suppressant is about 0.75 wt % to about 3 wt %, based on the total weight of the flame retarded polyolefin composition; the total amount of inorganic compounds is about 8 wt % to about 28 wt %, based on the total weight of the flame retarded polyolefin composition. Preferably, at least one phenolic antioxidant is also present in the flame retarded polyolefin composition.

In still another preferred embodiment in the polyolefin composition, a compatibilizer, preferably a styrene ethylene/butylene linear triblock copolymer, is present, the glow suppressant is melamine polyphosphate, and the inorganic compounds include antimony trioxide and talc; more preferably polytetrafluoroethylene is also present. When present, the polytetrafluoroethylene is in an amount of about 0.25 wt % to about 1.5 wt %, based on the total weight of the flame retarded polyolefin composition. In these preferred polyolefin compositions, the styrene ethylene/butylene linear triblock copolymer is preferably about 0.5 wt % to about 20 wt %, based on total weight of flame retarded polyolefin composition. More preferably, when a compatibilizer, preferably a styrene ethylene/butylene linear triblock copolymer, is present, the glow suppressant is melamine polyphosphate, and the inorganic compounds include antimony trioxide and talc, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the brominated flame retardant is about 20 to about 32 wt %, more preferably about 24 to about 30 wt %, based on total weight of flame retarded polyolefin composition; the melamine polyphosphate is about 1 wt % to about 3 wt %, based on the total weight of the flame retarded polyolefin composition; the total amount of inorganic compounds is about 8 wt % to about 28 wt %, based on the total weight of the flame retarded polyolefin composition. Preferably, at least one phenolic antioxidant is also present in the flame retarded polyolefin composition.

In another preferred embodiment in the polyolefin composition, a compatibilizer, preferably a styrene ethylene/butylene linear triblock copolymer, is present, the glow suppressant is a mixture of aluminum diethyl phosphinate, melamine polyphosphate, and zinc borate, and the inorganic compounds include antimony trioxide; more preferably both chlorinated polyethylene and polytetrafluoroethylene are also present. When present, the chlorinated polyethylene and the polytetrafluoroethylene are each in an amount of about 0.25 wt % to about 1.5 wt %, based on the total weight of the flame retarded polyolefin composition. In these preferred polyolefin compositions, the styrene ethylene/butylene linear triblock copolymer is preferably about 0.5 wt % to about 20 wt %, based on total weight of flame retarded polyolefin composition. More preferably, when a compatibilizer, preferably a styrene ethylene/butylene linear triblock copolymer, is present, the glow suppressant is a mixture of aluminum diethyl phosphinate, melamine polyphosphate, and zinc borate, and the inorganic compounds include antimony trioxide and talc, the brominated flame retardant is a brominated anionic styrenic polymer having a number average molecular weight of about 1000 to about 4000, and about 70 wt % to about 77 wt % bromine, even more preferably about 72 wt % to about 76 wt % bromine. In these preferred embodiments, the brominated flame retardant is about 20 to about 34 wt %, more preferably about 24 to about 32 wt %, based on total weight of flame retarded polyolefin composition; the glow suppressant is about 1 wt % to about 3 wt %, based on the total weight of the flame retarded polyolefin composition; the total amount of inorganic compounds is about 8 wt % to about 28 wt %, based on the total weight of the flame retarded polyolefin composition. Preferably, at least one phenolic antioxidant is also present in the flame retarded polyolefin composition.

### Processes for Forming Flame Retarded Polyolefin Compositions

The processes for forming flame retarded polyolefin compositions of the invention comprise combining at least one brominated flame retardant, at least one glow suppressant, and at least one inorganic compound. A flame retardant amount of the brominated flame retardant is used. The brominated flame retardant contains aromatically-bound bromine and is a brominated anionic styrenic polymer having a number average molecular weight of about 750 to about 7500, and/or a bromine content of about 60 wt % to about 77 wt %, and/or a brominated anionic chain transfer vinyl aromatic polymer which contains about 70 wt % or more bromine.

When preparing flame retarded polyolefin compositions of this invention, the individual components of the flame retardant composition of this invention can be blended separately and/or in subcombinations with the substrate or host polymer in appropriate proportions.

When the flame retarded polyolefin composition is formed from a flame retardant additive composition, the flame retardant additive composition is typically about 40 wt % or more of the flame retarded polyolefin composition, or about 40 wt % to about 80 wt % of the flame retarded polyolefin composition, based on the total weight of the flame retarded polyolefin composition.

Various known procedures can be used to prepare the flame retardant additive compositions, flame retarded polyolefin compositions, and masterbatches of this invention. The compounding of the brominated flame retardant, and the other ingredients can be done on compounding equipment such as a single screw extruder, a twin screw extruder, or a Buss kneader. Preferably, the compounding uses an extruder, more preferably a twin-screw extruder. The other ingredients utilized in the practice of this invention can be added in the initial feed port of the extruder or they can be added to the extruder further downstream. When using a twin-screw extruder and glass fibers are a component, it is desirable to add the glass fibers at a downstream portion of the extruder in order to avoid excessive glass fiber breakage. In an extruder, many ingredients typically melt as they are mixed together. The extrudate from the extruder is typically converted into granules or pellets either by cooling strands of the extruding polymer and subdividing the solidified strands into granules or pellets, or by subjecting the extrudate to concurrent die-faced pelletizing and water-cooling or air-cooling. If desired, the compositions of this invention can be formulated as powder or granular blends of the ingredients of the composition.

The brominated flame retardants and preferences therefor are as described above for the flame retardant additive compositions. Amounts and preferred amounts for the brominated flame retardants are as described above for the flame retarded polyolefin compositions.

The brominated flame retardants, glow suppressants, inorganic compounds, antioxidants, impact modifiers, compatibilizers, halogenated polyethylenes, pigments, and preferences therefor, are as described above for the flame retardant additive compositions. Amounts and preferred amounts for these components are as described above for the flame retarded polyolefin compositions.

Polyolefins and preferences therefor are as described above for the flame retarded polyolefin compositions.

### Additional Flame Retarded Polyolefin Compositions

Another flame retarded polyolefin composition of this invention comprises at least one polyolefin and a flame retardant amount of at least one brominated flame retardant that contains aromatically-bound bromine and is a brominated anionic styrenic polymer having a number average molecular weight of about 750 to about 7500, and/or a bromine content of about 60 wt % to about 77 wt %. In these flame retarded polyolefin compositions, the flame retardant amount is preferably about 5 wt % or more, more preferably about 10 wt % or more, at which amount the polyolefin composition may pass some flammability tests, such as the V-2 standard in the UL-94 vertical burn test. It is often preferred that the polyolefin composition meet a more rigorous standard, such as V-0 in the UL-94 vertical burn test, for which a higher amount of brominated flame retardant is usually needed, typically about 23 wt % or more. The flame retardant amount is preferably about 23 wt % or more, more preferably about 23.5 wt % or more, based on the total weight of the flame retarded polyolefin composition. In some of these embodiments, the flame retardant amount is preferably about 23 wt % to about 30 wt %, more preferably about 23.5 wt % to about 27 wt %, based on the total weight of the flame retarded polyolefin composition.

The number average molecular weight and preferences therefor and the bromine content of the brominated anionic styrenic polymer and preferences therefor are as described above. The other components of these flame retarded polyolefin compositions, the preferences therefor, as well as the amounts of the other components and the preferences therefor, are as described above, except that a glow suppressant is not present in these flame retarded polyolefin compositions. The processes for forming these flame retarded polyolefin compositions are similar to those described above, except that a glow suppressant is not included as one of the ingredients.

### Masterbatches

Masterbatches comprising a polyolefin and at least one brominated flame retardant can be formed. A masterbatch is usually a mixture having a high concentration of the brominated flame retardant relative to the polyolefin. Normally, the masterbatch is later blended with more polyolefin to form an end product with the desired ratios of brominated flame retardant, other ingredients, and polyolefin. In the practice of this invention, the brominated flame retardant is a) a brominated anionic styrenic polymer having a number average molecular weight of about 750 to about 7500, and/or a bromine content of about 60 wt % to about 77 wt %, b) a brominated anionic chain transfer vinyl aromatic polymer which contains about 70 wt % or more bromine, or a mixture of any two or more of these; brominated anionic styrenic polymers are preferred.

In a masterbatch, the amount of brominated flame retardant is usually about 10 wt % to about 90 wt %, preferably about 20 wt % to about 80 wt % of the masterbatch, based on the total weight of the masterbatch, but the amount of brominated flame retardant can be as high as about 99 wt %, based on the total weight of the masterbatch. Expressed as a weight ratio, the amount of brominated flame retardant to polyolefin can range from about 1:99 to about 99:1. Typical proportions in a masterbatch according to this invention are about 90:10 by weight brominated flame retardant:polyolefin; preferably about 80:20, more preferably about 70:30 brominated flame retardant:polyolefin. In some embodiments, the weight ratio of the brominated flame retardant to the polyolefin ranges from about 99:1 to about 50:50. In the masterbatches, the amount of brominated flame retardant is the total amount of brominated flame retardant when more than one brominated flame retardant is present in the masterbatch. When the only ingredients of the masterbatch are the brominated flame retardant and the polyolefin, the brominated flame retardant is preferably a brominated anionic styrenic polymer.

When a glow suppressant is present in a masterbatch with the brominated flame retardant and the polyolefin, the weight proportions can be described as ratios of components, where the brominated flame retardant weight proportion can be about 98 to about 20, the polyolefin weight proportion can be about 1 to about 80, and the glow suppressant weight proportion can be about 1 to about 20. For example, the weight proportions can be in the range of about 97:1.5:1.5 to about 50:49:1 brominated flame retardant:polyolefin:glow suppressant. In some embodiments, the weight ratio of the brominated flame retardant to polyolefin to glow suppressant ranges from about 90:2.5:7.5 to about 50:40:10; in other embodiments, a ratio of about 38:60:2 brominated flame retardant:polyolefin:glow suppressant is convenient. In still other embodiments, the weight ratio of the brominated flame retardant to polyolefin to glow suppressant ranges from about 75:5:15 to about 50:46:4. The amount of glow suppressant in these ratios is the total amount of glow suppressant when more than one glow suppressant is present in the masterbatch. Glow suppressants and preferences therefor are as described above.

When an inorganic compound is present in the masterbatch with the brominated flame retardant and the polyolefin, the weight proportions can be described as ratios of components, where the brominated flame retardant weight proportion can be about 98 to about 20, the polyolefin weight proportion can be about 1 to about 80, and the inorganic compound weight proportion can be about 1 to about 20. For example, the weight propoartions can be in the range of about 80:9:11 to about 50:36:14 brominated flame retardant:polyolefin: inorganic compound; this ratio can be varied very widely. In some embodiments, the weight ratio of the brominated flame retardant to polyolefin to inorganic compound ranges from about 50:10:40 to about 50:33.5:16.5. The amount of inorganic compound in these ratios is the total amount of inorganic compound when more than one inorganic compound is present in the masterbatch. Inorganic compounds and preferences therefor are as described above.

Some types of ingredients, for example the inorganic compound, may have one such compound present in the masterbatch, while one or more other inorganic compounds are added when the masterbatch is combined with additional polyolefin. In some preferred embodiments, the masterbatch comprises a brominated flame retardant, a polyolefin, and antimony trioxide, and in these preferred embodiments, the weight proportions can be in the range of about 85:10:5 to about 40:54:16 brominated flame retardant:polyolefin:antimony trioxide; this ratio can be varied very widely. In some embodiments, the weight ratio of the brominated flame retardant to polyolefin to antimony trioxide ranges from about 80:7:13 to about 47:50:3; in other embodiments, a ratio of about 60:20:20 brominated flame retardant:polyolefin:antimony trioxide being convenient.

In some preferred embodiments, the masterbatch comprises the brominated flame retardant, the polyolefin, the glow suppressant, and antimony trioxide. The weight proportions can be described as ratios of components, where the brominated flame retardant weight proportion can be about 98 to about 20, the polyolefin weight proportion can be about 1 to about 80, the glow suppressant weight proportion can be about 1 to about 20, and the antimony trioxide weight proportion can be about 1 to about 40. In some embodiments, the weight proportions can be in the range of about 97:1.5:1.5:5.6 to about 50:49:1:7.2 brominated flame retardant:polyolefin:glow suppressant: antimony trioxide. In some embodiments, the weight ratio of the brominated flame retardant to polyolefin to glow suppressant to antimony trioxide ranges from about 90:2.5:7.5:14.5 to about 50:40:10:3.2. The amount of glow suppressant in these ratios is the total amount of glow suppressant when more than one glow suppressant is present in the masterbatch.

Other desired ingredients, as described above for the flame retardant additive compositions and flame retarded polyolefin compositions, may be included as part of the masterbatch or added when the masterbatch is mixed with additional polyolefin. The amounts of such ingredients are normally and preferably proportioned so that when the masterbatch is blended with more polyolefin, the proportions are as described above for the flame retarded polyolefin compositions.

The flame retarded polyolefin compositions of this invention can be used to form articles by molding techniques, including but not limited to injection molding, gas assisted molding, rotomolding, compression molding, blow molding, film insert molding, structural foam molding, extrusion molding, and resin transfer molding. Other techniques that can be used to form articles from the flame retarded polyolefin compositions of this invention include thermoforming and extrusion (for example, of sheet, film, or fiber).

The following examples are presented for purposes of illustration, and are not intended to impose limitations on the scope of this invention.

### EXAMPLES—GENERAL

### Ingredients

The following is a list of ingredients used to make the flame retarded polyolefin samples in the Examples. Not all of the ingredients listed were used in each sample. Some of the ingredients may belong to more than one category. In the Tables, some of the ingredients used are referred to by their trade names.

### Polyolefins

Linear low density polyethylene (Petrothene® GA564189, melt flow index: 20 g/10 min. at 190° C./2.16 kg, LyondellBassell).
High density polyethylene (Alathon® LR590001, melt flow index: 0.8 g/10 min. at 190° C./2.16 kg, LyondellBassell).
Low density polyethylene (Lone Star 220, melt flow index: 2.0 g/10 min. at 190° C./2.16 kg, Lone Star Chemical).
Polypropylene (Profax 6523, melt flow index: 4.0 g/10 min. at 230° C./2.16 kg, LyondellBassell).
Polypropylene impact copolymers (PP7033N, melt flow index: 8 g/10 min. at 230° C./2.16 kg; PP7143KNE1, melt flow index: 10 g/10 min. at 230° C./2.16 kg; ExxonMobil Corporation).
Polypropylene impact copolymers (melt flow index: 12 g/10 min. and 17 g/10 min. at 230° C./2.16 kg; Lone Star Chemical).

### Brominated Flame Retardants

Brominated anionic chain transfer polystyrene which has a number average molecular weight of about 2087 and contains about 74 wt % bromine (Br-ACTSP; Albemarle Corporation).
Brominated anionic polystyrene which has a number average molecular weight (Mₙ) of about 2112 to about 2714 and a bromine content of about 72.8 wt % to about 74.9 wt % (Br-APS; Albemarle Corporation).
Brominated anionic polystyrene which has a number average molecular weight (Mₙ) of about 750 and a bromine content of about 73 wt % (Br-APS; Albemarle Corporation).
Decabromodiphenyl ethane (Saytex® 8010, Albemarle Corporation).
N,N-Ethylene-bis(tetrabromophthalimide) (Saytex® BT-93W, Albemarle Corporation).

### Glow Suppressants

Melamine polyphosphate (MPP; Melapur® 200, BASF Corporation).
Melamine poly(zinc phosphate), (Safire® 400, J. M. Huber Corporation).
Poly-[2,4-(piperazine-1,4-yl)-6-(morpholine-4-yl)-1,3,5-triazine] (or piperazine, polymer with morpholine-2,4,6-trichloro-1,3,5-triazine reaction product; MCA PPM Triazine HF); mixture of ammonium polyphosphate and MCA PPM Triazine HF (MCA PPM Triazine 765); mixture of ammonium polyphosphate, MCA PPM Triazine HF, and a carbon booster (MCA PPM Triazine 770), all products of MCA Technologies GmbH.
Mixture of about 63% aluminum diethyl phosphinate, about 32% melamine polyphosphate, and 4% to 5% zinc borate (Exolit® OP 1312, Clariant Ltd.).
Mixture of 2,5,8-triamino-1,3,4,6,7,9,9b-heptaazaphenalene and 2,2′-iminobis(4,6-diamino-1,3,5-triazine (Delflam 20; Delamin Ltd.).
Mixture of 55 to 65% piperazine pyrophosphate and 35 to 45% proprietary phosphoric acid compound (FP-2100J; Amfine Chemical Corporation).
2,2′-methylenebis(6-2H-benzotriazol-2-yl)-4-(1,1,3,3-tetramethylbutyl)phenol (ADK STAB LA-31);
2-(2-hydroxy-5-methylphenyl)benzotriazole (ADK STAB LA-32);
2-(4,6-diphenyl-1,3,5-triazin-2-yl)-5-[2-(2-ethylhexanoyloxy)ethoxy]phenol (ADK STAB LA-46);
1,2,3,4-butanetetracarboxylic acid polymer with 2,2-bis(hydroxymethyl)-1.3-propanediol and 3-hydroxy-2,2-dimethylpropanal, 1,2,2,6,6,-pentamethyl-4-piperidinyl ester (CAS® registry number 101357-36-2, ADK STAB LA-63P);
1,10-bis(2,2,6,6,-tetramethyl-4-piperidinyl) decanedioate (CAS® registry number 52829-07-9, ADK STAB LA-77);
bis(1-undecanoxy-2,2,6,6 tetramethyl-4-piperidinyl)carbonate (CAS® registry number 705257-84-7, ADK STAB LA-81);
Mixture of 50% to 60% piperazine pyrophosphate, 35% to 45% proprietary phosphoric acid compound and 3% to 6% zinc oxide (CAS® Registry No. 66034-17-1, ADK STAB FP-2500S); all “ADK” substances are products of Adeka Corporation.

### Inorganic Compounds

Antimony trioxide (Brightsun HB ATO, China Antimony Chemicals Corporation).
Zinc stannate (Flamtard S®, William Blythe Ltd.).
Zinc borate (Firebrake ZB; Rio Tinto).
Zinc sulfide (Sachtolith® HD-S, Venator Materials PLC).
TiO₂ (Kronos 2225, Kronos Incorporated).
Calcium stearate
Talc (microcrystalline; average particle size 2.2 μm, Mistron Vapor R, Imerys Performance Additives).
Aluminum phosphinate, calcium phosphinate (both products of GreenChemicals SpA).
Aluminum diethyl phosphinate (Exolit® OP 1230, Clariant Ltd.)
Basic zinc phosphate complex (Kemgard® 981); zinc molybdate/magnesium hydroxide complex (Kemgard® MZM), both products of J. M. Huber Corporation.
Halloysite clay (Dragonite® XR and Dragonite® HP, which are tubular mineral nanomaterials naturally exfoliated), both products of Applied Minerals Inc.
Silane-modified aluminum silicate (Burgess K E; Burgess Pigment Company).
Glass fibers: 3.2 or 4.5 mm long, 13 μm average diameter (Chop Vantage® HP 3299, Nippon Electric Glass Co., Ltd.).
Glass fibers: 4.5 mm long, 13 μm average diameter (Chop Vantage® HP 3293, PPG Industries or Nippon Electric Glass Co., Ltd.).
Chopped stranded fiberglass, (HP3293), PPG Industries.
Magnesium aluminum hydroxide carbonate (hydrotalcite, DHT-4A®-2; Kisuma Chemicals).
Magnesium hydroxide (Magnifin® H-5 IV; Huber Martinswerk GmbH).
Mixture of 25% to 50% calcium borate and 50% to 75% wollastonite (Halox® 1120F; ICL Specialty Products Inc.)

### Antioxidants

Tetrakis(3-(4-hydroxy-3,5-di-tert-butylphenyl)propionyloxymethyl)-methane (Ethanox® 310 antioxidant); tris-(2,4-di-tert-butylphenyl) phosphite (Ethaphos® 368 antioxidant), both products of SI Group.

### Impact Modifiers

Ethylene octene copolymer (Engage® XLT-8677; Dow Chemical).

### Compatibilizers

Styrene ethylene/butylene linear triblock copolymer (57% polystyrene, Kraton® A1535 H SEBS; Kraton Corporation).
Maleic anhydride modified polypropylene homopolymer (Polybond® 3200, SI Group).
Sodium ionomer of ethylene/methacrylic acid copolymer (Surlyn® 8920, Dow Chemical Company).

### Halogenated Polyethylenes

### Polytetrafluoroethylene

Chlorinated polyethylene (Weipren® CPE 6025 M, Lianda Corporation).

### Pigments

Pigment Brown 24 (a mixed oxide of chromium, antimony, and titanium; Sicotan® Yellow K 2001 FG);
Pigment Yellow 53 (a mixed compound of chromium, nickel, and titanium; Sicotan Yellow L 1010);
Solvent Yellow 163 (1,8-bis(phenylthio)anthracene-9,10-dione; Oracet® Yellow 180); carbon black (Microlen® Black 0068, 53% C black); all products of BASF Corporation.

### Other

Mixture of ammonium polyphosphate and an aromatic ester of tris-(2-hydroxy-ethyl)isocyanurate (Exolit® AP 750, Clariant Ltd.).

### Analytical Methods

Known analytical methods can be used or adapted for use in assaying the characteristics of the brominated flame retardants used in the practice of this invention, and to characterize the flame retarded polyolefin compositions of this invention. The following methods were used to measure the brominated flame retardants used, and/or the flame retarded polyolefin compositions formed, as applicable.

Total Bromine Content. Since anionic chain transfer vinyl aromatic polymers and brominated anionic styrenic polymers have some solubility in solvents such as dichloromethane, the determination of the total bromine content for these brominated flame retardants is accomplished by using conventional ¹H nuclear magnetic resonance spectroscopy (NMR) techniques. The samples analyzed were dilute samples, usually 0.2 g of brominated flame retardant in about 1.5 g to about 2 g deuterated dichloromethane. The NMR spectrometer was a Bruker Ascend 500 Spectrometer with the magnet at a ¹H frequency of 500 MHz for proton observation. Chemical shifts were determined using the protonated solvent residual at resonance set at δ 5.32 ppm. The bromine content was determined by calculating the difference between the ratio of the integration of the proton signal of the aromatic region to the proton signal of the aliphatic region of an unbrominated polystyrene chain of known average molecular weight and the ratio of the integration of the proton signal of the aromatic region to the proton signal of the aliphatic region of the brominated flame retardant, and attributing the difference to the bromine atoms present on the aromatic rings of the brominated flame retardant. The total bromine content values reported in the Examples were determined by this NMR method.

GPC light scattering number average molecular weight. The number average molecular weights (Mₙ) of the brominated flame retardants were determined by GPC light scattering using a Viscotek GPCmax VE2001 TDA nodular system equipped with an integrated UV detector (set at 254 nm), which includes a refractive index detector (RI) along with a dual angle light scattering detector, a combination pump and autosampler, and temperature controlled column compartment (Malvern. Panalytical Ltd.). Two 300 mm×7.5 mm OligoPore® columns with a pore size of 100 Å (Agilent Technologies, Inc.) were used for the analysis. The solvent was tetrahydrofuran (THF, HPLC grade), the flowrate was 1 mL/minute, and the column and pump oven temperatures were set at 40° C. The samples were prepared by dissolving 10 mg of the sample in 10 mL THF. An aliquot of this solution was filtered using 0.45 μm syringe filter, and 200 μL of the filtered solution was injected into the column. To calibrate, a first run containing 1,3-diphenylbutane and 1,3,5-triphenylhexane (adducts) was analyzed, and their peaks were assigned. Then a run was performed on an unbrominated sample of anionic polystyrene or anionic chain transfer polystyrene, and based on size exclusion as the mode of separation, peaks were identified according to their order of elution as 1,3-diphenylbutane (dimer), 1,3,5-triphenylhexane (trimer), tetraphenyloctane (tetramer), 1,3,5,7,9-pentaphenyldecane (pentamer), and so forth, based on comparison with the peaks from the adducts run. In each run for the brominated material, ten individual peaks were assigned theoretical molecular weight values based on the percentage of bromination, and a calibrated curve was constructed using these theoretical values and their corresponding retention times, as compared to the assigned peaks of the unbrominated material. From this calibrated curve for the brominated sample, the overall distribution data were calculated and reported. The molecular weight distribution calculations were performed by the Viscotek Omni SEC® software version 4.2.0.237 for gel permeation on chromatography (GPC) data collection and processing systems.

Particle size determinations were performed using a laser diffractometer (LS™-13 320, Beckman Coulter, Inc.). Results of the particle size reductions are summarized in Table 1 below.

UL-94 vertical burn test. The UL-94 vertical burn test for flammability was performed on bars at two thicknesses, 3.2 mm and 1.6 mm. The time to extinguish the flame was measured, and for some samples the time for the glow (afterglow) to disappear was also measured. Afterglow, or glow, is defined in the UL-94 vertical burn test as “persistence of glowing combustion after both removal of the ignition source and the cessation of any flaming.” The UL-94 vertical burn test defines afterglow time (glow time) as “the length of time during which an afterglow persists under specified conditions.” The cutoff for the glow to disappear to pass the glow test is a time of 30 seconds. In the Examples below, UL-94 vertical burn tests were performed on bars of two thicknesses, 3.2 mm and 1.6 mm. The compositions were not optimized for the more stringent tests with the 1.6 mm bars, but the results for the 1.6 mm bars may be improved by small changes in the amounts of one or more of the flame retardant, glow suppressant, and/or inorganic compounds.

Melt Flow Index Test. To determine the melt flow index of the flame retarded polyolefin compositions of this invention, the procedure and test equipment of ASTM Test Method D1238-00 were used. The extrusion plastometer was operated at 2.16 kg applied pressure and at a temperature of 230° C. The samples used in the tests were flame retarded polyolefin compositions of this invention.

Polytetrafluoroethylene (PTFE) was added as a 5 wt % mixture in the polyolefin polymer.

Each sample was formed by mixing and melting together all of the ingredients in a twin screw extruder (ZSK30 (30 mm), Werner & Pfleiderer Coperion GmbH), each ingredient being fed separately in powder form, except for the glass fibers.

Each reported UL-94 vertical burn test result in the Examples below is an average of 5 runs. Each reported physical or mechanical property test result in the Examples below is an average of 3 runs.

In the Tables below, runs containing “—A” are comparative runs for the glow suppressant containing embodiments, and are inventive for the embodiments where the flame retardant is a brominated anionic styrenic polymer and no glow suppressant is present. Runs containing “—C” are comparative runs for both the glow suppressant containing embodiments and the embodiments where the flame retardant is a brominated anionic styrenic polymer and no glow suppressant is present.

In all of the tables below, the amounts of each ingredient and the amount of bromine are reported as wt %.

### EXAMPLE 1

Several samples containing a polypropylene homopolymer and a brominated anionic chain transfer polystyrene (Br-ACTSP) having a number average molecular weight (Mₙ) of about 2087 and 74 wt % bromine were prepared and subjected to the UL-94 vertical burn test. Amounts of the components and the flammability test results are listed in Table 1. Run A is comparative.

TABLE 1

| Run | | A-C | B | C | D |
|---|---|---|---|---|---|
| Polypropylene (Profax 6523) | | 50.1 | 49.1 | 48.1 | 47.1 |
| Br-ACTSP | | 25.7 | 25.7 | 25.7 | 25.7 |
| Ethanox 310 | | 0.1 | 0.1 | 0.1 | 0.1 |
| Ethaphos 368 | | 0.1 | 0.1 | 0.1 | 0.1 |
| Talc | | 14.0 | 14.0 | 14.0 | 14.0 |
| ATO | | 10.0 | 10.0 | 10.0 | 10.0 |
| Melamine polyphosphate | | 0.0 | 1.0 | 2.0 | 3.0 |
| Bromine | | 19.0 | 19.0 | 19.0 | 19.0 |
| UL-94, 3.2 mm | rating | V-0 | V-0 | V-0 | V-0 |
| | time, s | 17 | 11 | 8 | 7 |
| Afterglow for 3.2 mm, s | | 54 | 46 | 33 | 27 |
| UL-94, 1.6 mm | rating | V-0 | V-0 | V-0 | V-0 |
| | time, s | 27 | 13 | 7 | 9 |

| | | | | |
|---|---|---|---|---|
| Afterglow for 1.6 mm, s | 123 | 62 | 51 | 76 |
| MFI*, g/10 min | 8.7 | 8.8 | 7.5 | 7.2 |

*MFI = Melt flow index

### EXAMPLE 2

Several samples containing a polypropylene impact copolymer and a brominated anionic polystyrene (Br-APS) having a number average molecular weight (Mₙ) of about 2112 and 73.3 wt % bromine were prepared and subjected to the UL-94 vertical burn test. Amounts of the components and the flammability test results are listed in Table 2. The amount of bromine in each sample was 19.0 wt %.

TABLE 2

| Run | | A | B | C |
|---|---|---|---|---|
| Impact copolymer (PP7033N) | | 51.1 | 50.1 | 49.1 |
| Br-APS | | 25.4 | 25.4 | 25.4 |
| ATO | | 8.3 | 8.3 | 8.3 |
| Ethaphos 368 | | 0.1 | 0.1 | 0.1 |
| Ethanox 310 | | 0.1 | 0.1 | 0.1 |
| Talc | | 14.0 | 14.0 | 14.0 |
| Melamine polyphosphate | | 1.0 | 2.0 | 3.0 |
| UL-94, 3.2 mm | rating | V-1 | V-0 | V-0 |
| | time, s | 49 | 29 | 19 |
| Afterglow for 3.2 mm, s | | 38 | 6 | 0 |
| UL-94, 1.6 mm | rating | V-0 | V-0 | V-0 |
| | time, s | 45 | 28 | 18 |

| | | | |
|---|---|---|---|
| Afterglow for 1.6 mm, s | 71 | 58 | 48 |

### EXAMPLE 3

Several samples containing a polypropylene impact copolymer and a brominated anionic polystyrene having a number average molecular weight (Mₙ) of about 2112 and 73.3 wt % bromine were prepared and subjected to the UL-94 vertical burn test. Amounts of the components and the flammability test results are listed in Table 3A. Additional properties of these samples are listed in Table 3B.

TABLE 3A

| | | Run | | | | | | |
|---|---|---|---|---|---|---|---|---|
| | | A | B | C | D | E | F | G |
| Polypropylene | | 27.3 | 42.3 | 31.5 | 46.5 | 41.5 | 0 | 0 |
| (PP7143KNE1) | | | | | | | | |
| Impact copolymer | | 0 | 0 | 0 | 0 | 0 | 31.1 | 31.9 |
| (PP7033N) | | | | | | | | |
| Br-APS | | 24.3 | 24.3 | 25.7 | 25.7 | 25.7 | 25.4 | 25.4 |
| ATO | | 7.2 | 7.2 | 7.6 | 7.6 | 7.6 | 8.3 | 7.5 |
| Ethaphos 368 | | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 |
| Talc | | 20.0 | 20.0 | 14.0 | 14.0 | 14.0 | 14.0 | 14.0 |
| Melamine | | 1.0 | 1.0 | 1.0 | 1.0 | 1.0 | 1.0 | 1.0 |
| polyphosphate | | | | | | | | |
| 5% PTFE in | | 20.0 | 5.0 | 20.0 | 5.0 | 10.0 | 20.0 | 20.0 |
| polypropylene | | | | | | | | |
| Bromine | | 18.0 | 18.0 | 19.0 | 19.0 | 19.0 | 19.0 | 19.0 |
| UL-94, 3.2 mm | rating | V-0 | V-0 | V-0 | V-0 | V-0 | V-0 | V-0 |
| | time, s | 7.7 | 7.24 | 8.01 | 11.01 | 11.03 | 10 | 9 |
| Afterglow for 3.2 mm, s | | 0 | 0 | 16 | 0 | 0 | 29 | 34 |
| UL-94, 1.6 mm | rating | V-0 | V-0 | V-0 | V-0 | V-0 | V-0 | V-0 |
| | time, s | 8.25 | 14.04 | 8.52 | 21.35 | 20.79 | 11 | 11 |

| | | | | | | | |
|---|---|---|---|---|---|---|---|
| Afterglow for 1.6 mm, s | 88 | 91 | 72 | 78 | 83 | 79 | 71 |

TABLE 3B

| Run | A | B | C | D | E |
|---|---|---|---|---|---|
| MFI (g/10 min) | 6.02 | 10.14 | 6.97 | 10.73 | 13.71 |
| Heat distortion temp., ° C. | 117.5 | 116.6 | 116 | 115.1 | 114 |
| Vicat softening temp., ° C. | 143.3 | 144.1 | 142.8 | 142.7 | 143.2 |
| Break strength, MPa | 22 | 21 | 22 | 20 | 20 |
| Tensile modulus, MPa | 3089 | 2837 | 2725 | 2562 | 2452 |
| Elongation at break, % | 1.41 | 1.32 | 1.73 | 1.9 | 1.73 |
| Flexural strength, MPa | 27 | 26 | 27 | 26 | 25 |
| Flexural modulus, MPa | 1507 | 1444 | 1355 | 1278 | 1228 |
| Izod Impact-notched, kJ/m² | 1.4 | 1.23 | 2.02 | 1.45 | 1.4 |
| Dielectric strength, kV/mm | 22.88 | 21.72 | 21.88 | 22.22 | 21.46 |
| Dielectric constant | 2.56 | 2.567 | 2.517 | 2.523 | 2.521 |
| Dissipation factor | 0.0023 | 0.0023 | 0.0015 | 0.0018 | 0.0018 |
| Volume resistivity, ohm · cm | 1.18 × 10¹⁷ | 3.05 × 10¹⁷ | 2.39 × 10¹⁷ | 1.64 × 10¹⁷ | 3.68 × 10¹⁷ |
| Surface resistivity, ohm (/sq) | 3.04 × 10¹⁷ | 5.77 × 10¹⁶ | 8.10 × 10¹⁶ | 5.38 × 10¹⁷ | 9.07 × 10¹⁶ |

### EXAMPLE 4

Several samples containing a polypropylene impact copolymer and a brominated anionic polystyrene having a number average molecular weight (Mₙ) of about 2250 and 73.3 wt % bromine were prepared and subjected to the UL-94 vertical burn test. Amounts of the components and the flammability test results, along with some additional properties of these samples, are listed in Table 4.

TABLE 4

| | | Run | | | | | | | | |
|---|---|---|---|---|---|---|---|---|---|---|
| | | A | B | C | D | E | F | G | H | I |
| Impact copolymer | | 51.5 | 48.5 | 46.5 | 41.5 | 43.5 | 41.5 | 36.5 | 28.5 | 21.5 |
| (Lone Star; MFI = 12) | | | | | | | | | | |
| Br-APS | | 25.7 | 25.7 | 25.7 | 25.7 | 25.7 | 25.7 | 25.7 | 25.7 | 25.7 |
| ATO | | 7.6 | 7.6 | 7.6 | 7.6 | 7.6 | 7.6 | 7.6 | 7.6 | 7.6 |
| Ethaphos 368 | | 0.1 | 0.1 | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 | 0.1 | 0.1 |
| Talc | | 14.0 | 14.0 | 14.0 | 14.0 | 14.0 | 14.0 | 14.0 | 14.0 | 14.0 |
| Melamine | | 1.0 | 1.0 | 1.0 | 1.0 | 1.0 | 1.0 | 1.0 | 1.0 | 1.0 |
| polyphosphate | | | | | | | | | | |
| 5% PTFE in | | 0.0 | 0.0 | 0.0 | 0.0 | 5.0 | 5.0 | 5.0 | 20.0 | 20.0 |
| polypropylene | | | | | | | | | | |
| Engage XLT 8677 | | 0.0 | 3.0 | 5.0 | 10.0 | 3.0 | 5.0 | 10.0 | 3.0 | 10.0 |
| Bromine | | 19.0 | 19.0 | 19.0 | 19.0 | 19.0 | 19.0 | 19.0 | 19.0 | 19.0 |
| UL-94, 3.2 mm | rating | V-0 | V-0 | V-0 | V-0 | V-0 | V-0 | V-0 | V-0 | V-0 |
| | time, s | 16.01 | 12.99 | 15.52 | 11.8 | 17.95 | 13.39 | 12.12 | 8.27 | 8.29 |
| Afterglow for 3.2 mm, s | | 0 | 0 | 0 | 0 | 23 | 17 | 22 | 38 | 38 |
| UL-94, 1.6 mm | rating | V-0 | V-0 | V-0 | V-0 | V-0 | V-0 | V-0 | V-0 | V-0 |
| | time, s | 21.69 | 17.97 | 20.43 | 20.66 | 13.82 | 17.48 | 11.61 | 10.11 | 9.17 |

| | | | | | | | | | |
|---|---|---|---|---|---|---|---|---|---|
| Afterglow for 1.6 mm, s | 77 | 71 | 76 | 70 | 75 | 77 | 90 | 73 | 82 |
| MFI (g/10 min) | 17.08 | 14.66 | 13.41 | 12.23 | 14.33 | 13.66 | 10.46 | 9.25 | 6.23 |
| Break strength, MPa | 20 | 17 | 14 | 11 | 17 | 16 | 11 | 17 | 11 |
| Tensile modulus, MPa | 2295 | 2053 | 1888 | 1621 | 2059 | 1956 | 1658 | 2159 | 1827 |
| Elongation at break, % | 1.94 | 2.4 | 5.56 | 8.66 | 2.57 | 2.37 | 5.99 | 3.15 | 10.75 |
| Izod Impact-notched, | 2.55 | 2.84 | 3.29 | 23.48 | 2.71 | 2.83 | 14.22 | 3.14 | 24.73 |
| kJ/m² | | | | | | | | | |

### EXAMPLE 5

Several samples containing a polypropylene impact copolymer and a brominated anionic polystyrene having a number average molecular weight (Mₙ) of about 2167 and 73.3 wt % bromine were prepared and subjected to the UL-94 vertical burn test. Amounts of the components and the flammability test results, along with some additional properties of these samples, are listed in Table 5.

TABLE 5

| Run | | A | B | C | D | E |
|---|---|---|---|---|---|---|
| Impact copolymer (Lone Star; MFI = 12) | | 51.2 | 51.0 | 50.5 | 45.5 | 40.5 |
| Br-APS | | 25.7 | 25.7 | 25.7 | 25.7 | 25.7 |
| ATO | | 7.6 | 7.6 | 7.6 | 7.6 | 7.6 |
| Ethaphos 368 | | 0.1 | 0.1 | 0.1 | 0.1 | 0.1 |
| Ethanox 310 | | 0.1 | 0.1 | 0.1 | 0.1 | 0.1 |
| Talc | | 14.0 | 14.0 | 14.0 | 14.0 | 14.0 |
| Melamine polyphosphate | | 1.0 | 1.0 | 1.0 | 1.0 | 1.0 |
| Chloro-PE | | 0.25 | 0.5 | 1.0 | 1.0 | 1.0 |
| Engage XLT 8677 | | 0.0 | 0.0 | 0.0 | 5.0 | 10.0 |
| Bromine | | 19.0 | 19.0 | 19.0 | 19.0 | 19.0 |
| UL-94, 3.2 mm | rating | V-0 | V-0 | V-0 | V-0 | V-0 |
| | time, s | 7.48 | 11.17 | 10.04 | 9.25 | 8.73 |
| Afterglow for 3.2 mm, s | | 0 | 0 | 0 | 0 | 0 |
| UL-94, 1.6 mm | rating | V-0 | V-0 | V-0 | V-0 | V-0 |
| | time, s | 20.06 | 18.63 | 21.08 | 27.81 | 19.63 |

| | | | | | |
|---|---|---|---|---|---|
| Afterglow for 1.6 mm, s | 78 | 71 | 88 | 94 | 71 |
| MFI (g/10 min) | 12.58 | 10.53 | 9.81 | 8.47 | 6.75 |
| Break strength, MPa | 20 | 19 | 17 | 12 | 9 |
| Tensile modulus, MPa | 2410 | 2241 | 2186 | 1834 | 1500 |
| Elongation at break, % | 2.09 | 2.4 | 3.69 | 16.56 | 53.22 |
| Izod Impact-notched, kJ/m² | 2.54 | 2.67 | 2.9 | 7.63 | 41.26 |

### EXAMPLE 6

Several samples containing a polypropylene impact copolymer and a brominated anionic polystyrene having a number average molecular weight (Mₙ) of about 2167 and 73.3 wt % bromine were prepared and subjected to the UL-94 vertical burn test. Amounts of the components and the flammability test results, along with some additional properties of these samples, are listed in Table 6.

TABLE 6

| | | Run | | | | | | | |
|---|---|---|---|---|---|---|---|---|---|
| | | A | B | C | D | E | F | G | H |
| Impact copolymer (Lone | | 31.5 | 16.5 | 36.2 | 35.5 | 26.5 | 11.5 | 31.2 | 30.5 |
| Star; MFI = 12) | | | | | | | | | |
| Br-APS | | 25.7 | 25.7 | 25.7 | 25.7 | 25.7 | 25.7 | 25.7 | 25.7 |
| ATO | | 7.6 | 7.6 | 7.6 | 7.6 | 7.6 | 7.6 | 7.6 | 7.6 |
| Ethaphos 368 | | 0.1 | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 | 0.1 |
| Talc | | 14.0 | 14.0 | 14.0 | 14.0 | 14.0 | 14.0 | 14.0 | 14.0 |
| Melamine | | 1.0 | 1.0 | 1.0 | 1.0 | 1.0 | 1.0 | 1.0 | 1.0 |
| polyphosphate | | | | | | | | | |
| 5% PTFE in | | 5.0 | 20.0 | 0 | 0 | 5.0 | 20.0 | 0 | 0 |
| polypropylene | | | | | | | | | |
| Chloro-PE | | 0.0 | 0.0 | 0.25 | 1.0 | 0.0 | 0.0 | 0.25 | 1.0 |
| Engage XLT 8677 | | 15.0 | 15.0 | 15.0 | 15.0 | 20.0 | 20.0 | 20.0 | 20 |
| Bromine | | 19.0 | 19.0 | 19.0 | 19.0 | 19.0 | 19.0 | 19.0 | 19.0 |
| UL-94, 3.2 mm | rating | V-0 | V-0 | V-0 | V-0 | V-0 | V-0 | V-0 | V-0 |
| | time, s | 7.5 | 7.55 | 8.27 | 7.45 | 9.29 | 10.02 | 8.22 | 7.35 |
| Afterglow for 3.2 mm, s | | 36 | 46 | 58 | 45 | 36 | 46 | 53 | 35 |
| UL-94, 1.6 mm | rating | V-0 | V-0 | V-0 | V-0 | V-0 | V-0 | V-0 | V-0 |
| | time, s | 8.57 | 7.79 | 11.16 | 10.73 | 9.26 | 7.1 | 7.71 | 10.26 |

| | | | | | | | | |
|---|---|---|---|---|---|---|---|---|
| Afterglow for 1.6 mm, s | 67 | 88 | 60 | 102 | 80 | 44 | 69 | 92 |
| MFI, g/10 min | 9.08 | 5.91 | 8.18 | 6.81 | 7.17 | 4.72 | 5.86 | 5.82 |
| Break strength, MPa | 12 | 13 | 12 | 11 | 10 | 10 | 9 | 9 |
| Tensile modulus, MPa | 1403 | 1534 | 1363 | 1299 | 1159 | 1219 | 987 | 953 |
| Elongation at yield, % | 2.27 | 2.22 | 2.62 | 2.9 | 2.91 | 3.06 | 3.61 | 4.66 |
| Elongation at break, % | 22.69 | 28.04 | 58.12 | 114.04 | 76.34 | 127.97 | 123.55 | 173.71 |
| Izod Impact-notched, kJ/m² | 45.1 | 45.7 | 53.8 | 59.4 | 56.5 | 59.7 | 59 | 61.6 |

### EXAMPLE 7

Several samples containing a polypropylene impact copolymer and a brominated anionic polystyrene having a number average molecular weight (Mₙ) of about 2167 and 73.3 wt % bromine were prepared and subjected to the UL-94 vertical burn test. Amounts of the components and the flammability test results, along with some additional properties of these samples, are listed in Table 7.

TABLE 7

| | | Run | | | | | | | | |
|---|---|---|---|---|---|---|---|---|---|---|
| | | A | B | C | D | E | F | G | H | I |
| Impact copolymer (Lone | | 31.2 | 36.0 | 40.7 | 26.2 | 31.0 | 35.7 | 21.2 | 26.0 | 30.7 |
| Star; MFI = 12) | | | | | | | | | | |
| Br-APS | | 25.7 | 25.7 | 25.7 | 25.7 | 25.7 | 25.7 | 25.7 | 25.7 | 25.7 |
| ATO | | 7.6 | 7.6 | 7.6 | 7.6 | 7.6 | 7.6 | 7.6 | 7.6 | 7.6 |
| Ethaphos 368 | | 0.1 | 0.1 | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 | 0.1 | 0.1 |
| Talc | | 14.0 | 14.0 | 14.0 | 14.0 | 14.0 | 14.0 | 14.0 | 14.0 | 14.0 |
| Melamine | | 1.0 | 1.0 | 1.0 | 1.0 | 1.0 | 1.0 | 1.0 | 1.0 | 1.0 |
| polyphosphate | | | | | | | | | | |
| Engage XLT 8677 | | 5.0 | 5.0 | 5.0 | 10.0 | 10.0 | 10.0 | 15.0 | 15.0 | 15.0 |
| 5% PTFE in | | 15.0 | 10.0 | 5.0 | 15.0 | 10.0 | 5.0 | 15.0 | 10.0 | 5.0 |
| polypropylene | | | | | | | | | | |
| Chloro-PE | | 0.25 | 0.5 | 0.75 | 0.25 | 0.5 | 0.75 | 0.25 | 0.5 | 0.75 |
| Bromine | | 19.0 | 19.0 | 19.0 | 19.0 | 19.0 | 19.0 | 19.0 | 19.0 | 19.0 |
| UL-94, 3.2 mm | rating | V-0 | V-0 | V-0 | V-0 | V-0 | V-0 | V-0 | V-0 | V-0 |
| | time, s | 7.46 | 9.05 | 7.06 | 7.01 | 7.18 | 11.06 | 7.44 | 6.83 | 9.68 |
| Afterglow for 3.2 mm, s | | 34 | 7 | 9 | 43 | 20 | 9 | 54 | 18 | 0 |
| UL-94, 1.6 mm | rating | V-0 | V-0 | V-0 | V-0 | V-0 | V-0 | V-0 | V-0 | V-0 |
| | time, s | 7.55 | 9.07 | 9.63 | 7.75 | 8.97 | 12.18 | 7.98 | 7.56 | 13.69 |

| | | | | | | | | | |
|---|---|---|---|---|---|---|---|---|---|
| Afterglow for 1.6 mm, s | 42 | 71 | 87 | 47 | 44 | 74 | 52 | 82 | 79 |
| MFI (g/10 min) | 7.59 | 7.85 | 9.69 | 6.11 | 7.69 | 8.26 | 5.32 | 5.94 | 6.63 |
| Tensile break stress | 15 | 15 | 15 | 10 | 10 | 11 | 9 | 9 | 8 |
| Tensile modulus, MPa | 2221 | 2074 | 1960 | 1803 | 1768 | 1718 | 1512 | 1387 | 1326 |
| Elongation at yield, % | — | — | — | 2.29 | 2.4 | 2.4 | 2.64 | 2.75 | 2.9 |
| Elongation at break, % | 2.85 | 3.7 | 3.68 | 28.35 | 23.89 | 15.47 | 96.82 | 65.1 | 79.23 |
| Izod Impact-notched, | 4.85 | 5.19 | 5.41 | 29.36 | 31.29 | 30.68 | 54.22 | 55.07 | 57.37 |
| kJ/m² | | | | | | | | | |

### EXAMPLE 8

Several samples containing a polypropylene impact copolymer and a brominated polystyrene having a number average molecular weight (Mₙ) of about 2167 and 73.3 wt % bromine were prepared and subjected to the UL-94 vertical burn test. Amounts of the components and the flammability test results, along with some additional properties of these samples, are listed in Table 8.

TABLE 8

| | | Run | | | | | | | | |
|---|---|---|---|---|---|---|---|---|---|---|
| | | A | B | C | D | E | F | G | H | I |
| Impact copolymer (Lone | | 46.5 | 41.5 | 26.5 | 41.5 | 36.5 | 21.5 | 36.5 | 31.5 | 16.5 |
| Star; MFI = 12) | | | | | | | | | | |
| Br-APS | | 25.7 | 25.7 | 25.7 | 25.7 | 25.7 | 25.7 | 25.7 | 25.7 | 25.7 |
| ATO | | 7.6 | 7.6 | 7.6 | 7.6 | 7.6 | 7.6 | 7.6 | 7.6 | 7.6 |
| Ethaphos 368 | | 0.1 | 0.1 | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 | 0.1 | 0.1 |
| Talc | | 14.0 | 14.0 | 14.0 | 14.0 | 14.0 | 14.0 | 14.0 | 14.0 | 14.0 |
| Melamine | | 1.0 | 1.0 | 1.0 | 1.0 | 1.0 | 1.0 | 1.0 | 1.0 | 1.0 |
| polyphosphate | | | | | | | | | | |
| SEBS | | 5.0 | 5.0 | 5.0 | 10.0 | 10.0 | 10.0 | 15.0 | 15.0 | 15.0 |
| 5% PTFE in | | 0.0 | 5.0 | 20.0 | 0.0 | 5.0 | 20.0 | 0.0 | 5.0 | 20.0 |
| polypropylene | | | | | | | | | | |
| Bromine | | 19.0 | 19.0 | 19.0 | 19.0 | 19.0 | 19.0 | 19.0 | 19.0 | 19.0 |
| UL-94, 3.2 mm | rating | V-0 | V-0 | V-0 | V-0 | V-0 | V-0 | V-0 | V-0 | V-0 |
| | time, s | 7.49 | 7.58 | 7.73 | 7.32 | 7.41 | 6.92 | 7.34 | 7.21 | 8.29 |
| Afterglow for 3.2 mm, s | | 0 | 0 | 45 | 0 | 0 | 0 | 0 | 0 | 19 |
| UL-94, 1.6 mm | rating | V-0 | V-0 | V-0 | V-0 | V-0 | V-0 | V-0 | V-0 | V-0 |
| | time, s | 8.59 | 7.91 | 8.01 | 15.9 | 8.56 | 8.33 | 10.34 | 7.26 | 7.09 |

| | | | | | | | | | |
|---|---|---|---|---|---|---|---|---|---|
| Afterglow for 1.6 mm, s | 77 | 83 | 68 | 83 | 80 | 17 | 108 | 79 | 122 |
| MFI (g/10 min) | 10.66 | 8.79 | 5.3 | 5.35 | 4.12 | 1.98 | 2.23 | 1.52 | 0.83 |
| Tensile break stress | 18 | 17 | 17 | 13 | 12 | 12 | 10 | 10 | 10 |
| Tensile modulus, MPa | 2161 | 2201 | 2417 | 1861 | 1913 | 2010 | 1596 | 1573 | 1660 |
| Elongation at yield, % | | | | 2.02 | 1.97 | 1.93 | 2.29 | 2.32 | 2.24 |
| Elongation at break, % | 2.54 | 3.07 | 5.75 | 10.72 | 12.03 | 15.34 | 29.28 | 31.46 | 41.56 |
| Izod Impact-notched, | 3.47 | 3.65 | 5.28 | 14.06 | 8.85 | 17.94 | 51.31 | 43.44 | 48.7 |
| kJ/m² | | | | | | | | | |

### EXAMPLE 9

Several samples containing a polypropylene impact copolymer and a brominated anionic polystyrene were prepared and subjected to the UL-94 vertical burn test. The samples in Runs A and B contained Br-APS having a number average molecular weight (Mₙ) of about 2183 and 73.7 wt % bromine; the samples of Run C contained Br-APS with an Mₙ of about 2708 and 72.9 wt % bromine. Amounts of the components and the flammability test results, along with some additional properties of these samples, are listed in Table 9.

TABLE 9

| Run | | A | B | C |
|---|---|---|---|---|
| Impact copolymer (Lone Star; MFI = 17) | | 31.0 | 26.0 | 51.1 |
| Br-APS | | 25.7 | 25.7 | 26.1 |
| ATO | | 7.6 | 7.6 | 7.6 |
| Ethaphos 368 | | 0.1 | 0.1 | 0.1 |
| Ethanox 310 | | 0.1 | 0.1 | 0.1 |
| Talc | | 14.0 | 14.0 | 14.0 |
| Melamine polyphosphate | | 1.0 | 1.0 | 1.0 |
| Engage 8677 XLT | | 10.0 | 15.0 | 0.0 |
| PTFE | | 10.0 | 10.0 | 0.0 |
| Chloro-PE | | 0.5 | 0.5 | 0.0 |
| Bromine | | 19.0 | 19.0 | 19.0 |
| UL-94, 3.2 mm | rating | V-0 | V-0 | V-0 |
| | time, s | 10.28 | 10.4 | 7.25 |
| Afterglow for 3.2 mm, s | | 16 | 11 | 0 |
| UL-94, 1.6 mm | rating | V-1 | V-1 | V-0 |
| | time, s | 20.82 | 17.75 | 22.84 |

| | | | |
|---|---|---|---|
| Afterglow for 1.6 mm, s | 119 | 118 | 60 |
| Tensile strength, MPa | 15 | 12 | — |
| Tensile modulus, MPa | 1682 | 1413 | 2316 |
| Elongation at yield, % | 2.15 | 2.33 | — |
| Elongation at break, % | 27.05 | 38.69 | 1.61 |
| Flexural strength | 23 | 18 | 31 |
| Flexural modulus | 1405 | 1124 | 2234 |
| Izod Impact-notched, kJ/m² | 18.78 | 45.21 | 1.13 |

### EXAMPLE 10

Several samples containing a polypropylene impact copolymer and a brominated anionic polystyrene having a number average molecular weight (Mₙ) of about 2708 and 72.9 wt % bromine were prepared and subjected to the UL-94 vertical burn test. Amounts of the components and the flammability test results, along with some additional properties of these samples, are listed in Tables 10A and 10B.

TABLE 10A

| Run | | A-A | B-A | C-A | D-A |
|---|---|---|---|---|---|
| Impact copolymer (Lone Star; MFI = 17) | | 33.0 | 33.0 | 33.0 | 0 |
| Impact copolymer (Lone Star) | | 0 | 0 | 0 | 32.6 |
| Br-APS | | 25.7 | 25.7 | 25.7 | 26.1 |
| ATO | | 7.6 | 7.6 | 7.6 | 7.6 |
| Ethaphos 368 | | 0.1 | 0.1 | 0.1 | 0.1 |
| Ethanox 310 | | 0.1 | 0.1 | 0.1 | 0.1 |
| Talc | | 14.0 | 14.0 | 14.0 | 14.0 |
| Melamine polyphosphate | | 0.0 | 0.0 | 0.0 | 0.0 |
| Engage 8677 XLT | | 8.0 | 8.0 | 8.0 | 8.0 |
| 5% PTFE in polypropylene | | 10.0 | 10.0 | 10.0 | 10.0 |
| Chloro-PE | | 0.5 | 0.5 | 0.5 | 0.5 |
| Safire 400 | | 0 | 0 | 0 | 0 |
| Delflam 20 | | 0 | 0 | 0 | 0 |
| Kemgard MZM | | 1.0 | 0 | 0 | 0 |
| Exolit OP 1230 | | 0 | 0 | 0 | 0 |
| Exolit OP 1312 | | 0 | 0 | 0 | 0 |
| FP-2100J | | 0 | 0 | 0 | 0 |
| MCA PPM Triazine HF | | 0 | 0 | 0 | 0 |
| Zinc stannate | | 0 | 1.0 | 0 | 0 |
| Kemgard 981 | | 0 | 0 | 1.0 | 0 |
| Zn sulfide | | 0 | 0 | 0 | 1 |
| Bromine | | 19.0 | 19.0 | 19.0 | 19.0 |
| UL-94, 3.2 mm | rating | V-0 | V-0 | V-0 | V-0 |
| | time, s | 20.36 | 9.62 | 27.41 | 6.71 |
| Afterglow for 3.2 mm, s | | 11 | 0 | 16 | 0 |
| UL-94, 1.6 mm | rating | V-1 | V-1 | V-1 | V-1 |
| | time, s | 9.47 | 15.39 | 22.91 | 7.31 |

| | | | | |
|---|---|---|---|---|
| Afterglow for 1.6 mm, s | 154 | 146 | 154 | 197 |
| Tensile strength, MPa | 16 | 16 | 16 | 16 |
| Tensile modulus, MPa | 1876 | 1940 | 1824 | 1809 |
| Elongation at yield, % | 1.82 | 1.81 | 1.88 | 1.85 |
| Elongation at break,% | 8.67 | 4.99 | 6.43 | 7.28 |
| Izod Impact-notched, | 7.56 | 5.24 | 7.42 | 6.31 |
| kJ/m² | | | | |

TABLE 10B

| | | Run | | | | | | |
|---|---|---|---|---|---|---|---|---|
| | | E | F | G | H | I | J | K |
| Impact copolymer (Lone | | 33.0 | 33.0 | 33.0 | 33.0 | 33.0 | 33.0 | 33.0 |
| Star; MFI = 17) | | | | | | | | |
| Impact copolymer (Lone | | 0 | 0 | 0 | 0 | 0 | 0 | 0 |
| Star) | | | | | | | | |
| Br-APS | | 25.7 | 25.7 | 25.7 | 25.7 | 25.7 | 25.7 | 25.7 |
| ATO | | 7.6 | 7.6 | 7.6 | 7.6 | 7.6 | 7.6 | 7.6 |
| Ethaphos 368 | | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 |
| Talc | | 14.0 | 14.0 | 14.0 | 14.0 | 14.0 | 14.0 | 14.0 |
| Melamine | | 1.0 | 0.0 | 0.0 | 0.0 | 0.0 | 0.0 | 0.0 |
| polyphosphate | | | | | | | | |
| Engage 8677 XLT | | 8.0 | 8.0 | 8.0 | 8.0 | 8.0 | 8.0 | 8.0 |
| 5% PTFE in | | 10.0 | 10.0 | 10.0 | 10.0 | 10.0 | 10.0 | 10.0 |
| polypropylene | | | | | | | | |
| Chloro-PE | | 0.5 | 0.5 | 0.5 | 0.5 | 0.5 | 0.5 | 0.5 |
| Safire 400 | | 0 | 1.0 | 0 | 0 | 0 | 0 | 0 |
| Delflam 20 | | 0 | 0 | 1.0 | 0 | 0 | 0 | 0 |
| Kemgard MZM | | 0 | 0 | 0 | 0 | 0 | 0 | 0 |
| Exolit OP 1230 | | 0 | 0 | 0 | 1.0 | 0 | 0 | 0 |
| Exolit OP 1312 | | 0 | 0 | 0 | 0 | 1.0 | 0 | 0 |
| FP-2100J | | 0 | 0 | 0 | 0 | 0 | 1.0 | 0 |
| MCA PPM Triazine HF | | 0 | 0 | 0 | 0 | 0 | 0 | 1.0 |
| Zinc stannate | | 0 | 0 | 0 | 0 | 0 | 0 | 0 |
| Kemgard 981 | | 0 | 0 | 0 | 0 | 0 | 0 | 0 |
| Zn sulfide | | 0 | 0 | 0 | 0 | 0 | 0 | 0 |
| Bromine | | 19.0 | 19.0 | 19.0 | 19.0 | 19.0 | 19.0 | 19.0 |
| UL-94, 3.2 mm | rating | V-0 | V-0 | V-0 | V-0 | V-0 | V-0 | V-0 |
| | time, s | 9.79 | 11.42 | 8.31 | 23.75 | 22.4 | 18.23 | 12.2 |
| Afterglow for 3.2 mm, s | | 0 | 0 | 7 | 0 | 15 | 33 | 19 |
| UL-94, 1.6 mm | rating | V-0 | V-0 | V-0 | Fail | V-0 | V-0 | V-1 |
| | time, s | 14.245 | 8.97 | 7.35 | 143.54 | 29.4 | 10.96 | 11.19 |

| | | | | | | | |
|---|---|---|---|---|---|---|---|
| Afterglow for 1.6 mm, s | 65 | 111 | 89 | 25 | 6 | 107 | 171 |
| Tensile strength, MPa | 16 | 16 | 16 | n/a | 16 | 16 | n/a |
| Tensile modulus, MPa | 1847 | 1809 | 1852 | 1963 | 1980 | 1916 | 1916 |
| Elongation at yield, % | 1.88 | 1.82 | 1.76 | n/a | 1.77 | 1.87 | n/a |
| Elongation at break, % | 7.07 | 6.01 | 4.88 | 4.04 | 6.27 | 7.36 | 3.42 |
| Izod Impact-notched, | 5.6 | 5.47 | 4.61 | 6.79 | 7.91 | 6.62 | 4.09 |
| kJ/m² | | | | | | | |

### EXAMPLE 11

Several samples containing a polypropylene impact copolymer and a brominated anionic polystyrene were prepared and subjected to the UL-94 vertical burn test. Most of the samples contained Br-APS having a number average molecular weight (Mₙ) of about 2162 and 73.6 wt % bromine; The samples in Run E-A contained Br-APS with an Mₙ of about 2714 and 72.8 wt % bromine. Amounts of the components and the flammability test results, along with some additional properties of these samples, are listed in Tables 11A and 11B.

TABLE 11A

| | | Run | | | | |
|---|---|---|---|---|---|---|
| | | A-A | B-A | C-A | D-A | E-A |
| Impact copolymer | | 33.0 | 33.0 | 33.0 | 33.0 | 31.7 |
| (Lone Star) | | | | | | |
| Br-APS | | 25.7 | 25.7 | 25.7 | 25.7 | 26.1 |
| ATO | | 7.6 | 7.6 | 7.6 | 7.6 | 4.5 |
| Ethaphos 368 | | 0.1 | 0.1 | 0.1 | 0.1 | 0.1 |
| Ethanox 310 | | 0.1 | 0.1 | 0.1 | 0.1 | 0.1 |
| Talc | | 14.0 | 14.0 | 14.0 | 14.0 | 14.0 |
| Melamine polyphosphate | | 0.0 | 0.0 | 0.0 | 0.0 | 0.0 |
| Engage 8677 XLT | | 8.0 | 8.0 | 8.0 | 8.0 | 8.0 |
| 5% PTFE in | | 10.0 | 10.0 | 10.0 | 10.0 | 10.0 |
| polypropylene | | | | | | |
| Chloro-PE | | 0.5 | 0.5 | 0.5 | 0.5 | 0.5 |
| FP-2500S | | 0 | 0 | 0 | 0 | 0 |
| MCA PPM Triazine 765 | | 0 | 0 | 0 | 0 | 0 |
| MCA PPM Triazine 770 | | 0 | 0 | 0 | 0 | 0 |
| Mg(OH)₂ | | 0 | 0 | 0 | 1 | 0 |
| Exolit AP750 | | 1 | 0 | 0 | 0 | 0 |
| Zinc borate | | 0 | 0 | 0 | 0 | 5 |
| Halox 1120F | | 0 | 0 | 0 | 0 | 0 |
| Dragonite XR | | 0 | 1 | 0 | 0 | 0 |
| Dragonite HP | | 0 | 0 | 1 | 0 | 0 |
| Bromine | | 19.0 | 19.0 | 19.0 | 19.0 | 19.0 |
| UL-94, 3.2 mm | rating | V-0 | V-0 | V-0 | V-0 | V-0 |
| | time, s | 17.79 | 21.86 | 20.78 | 17.85 | 27.81 |
| Afterglow for 3.2 mm, s | | 7 | 23 | 20 | 20 | 0 |
| UL-94, 1.6 mm | rating | V-1 | V-1 | V-1 | V-1 | V-0 |
| | time, s | 11.65 | 12.28 | 7.73 | 10.47 | 15.41 |

| | | | | | |
|---|---|---|---|---|---|
| Afterglow for 1.6 mm, s | 176 | 169 | 142 | 176 | 61 |
| Tensile strength, MPa | N/A | N/A | N/A | 16 | 15 |
| Tensile modulus, MPa | 1935 | 1870 | 1903 | 1896 | 1751 |
| Elongation at yield, % | N/A | N/A | N/A | 1.78 | 1.98 |
| Elongation at break, % | 3.76 | 3.9 | 3.63 | 4.52 | 1180 |
| Izod Impact-notched, | 4.14 | 4.7 | 4.42 | 5.23 | 4.45 |
| kJ/m² | | | | | |

TABLE 11B

| | | Run | | | | | |
|---|---|---|---|---|---|---|---|
| | | A | B | C | D | E | F |
| Impact copolymer | | 33.0 | 33.0 | 33.0 | 33.0 | 33.0 | 33.0 |
| (Lone Star) | | | | | | | |
| Br-APS | | 25.7 | 25.7 | 25.7 | 25.7 | 25.7 | 25.7 |
| ATO | | 7.6 | 7.6 | 7.6 | 7.6 | 7.6 | 7.6 |
| Ethaphos 368 | | 0.1 | 0.1 | 0.1 | 0.1 | 0.1 | 0.1 |
| Ethanox 310 | | 0.1 | 0.1 | 0.1 | 0.1 | 0.1 | 0.1 |
| Talc | | 14.0 | 14.0 | 14.0 | 14.0 | 14.0 | 14.0 |
| Melamine polyphosphate | | 1.0 | 0.0 | 0.0 | 0.0 | 0.0 | 0.0 |
| Engage 8677 XLT | | 8.0 | 8.0 | 8.0 | 8.0 | 8.0 | 8.0 |
| 5% PTFE in | | 10.0 | 10.0 | 10.0 | 10.0 | 10.0 | 10.0 |
| polypropylene | | | | | | | |
| Chloro-PE | | 0.5 | 0.5 | 0.5 | 0.5 | 0.5 | 0.5 |
| FP-2500S | | 0 | 1 | 0 | 0 | 0 | 0 |
| MCA PPM Triazine 765 | | 0 | 0 | 1 | 0 | 0 | 0 |
| MCA PPM Triazine 770 | | 0 | 0 | 0 | 1 | 0 | 0 |
| Mg(OH)₂ | | 0 | 0 | 0 | 0 | 0 | 0 |
| Exolit AP750 | | 0 | 0 | 0 | 0 | 0 | 0 |
| Zinc borate | | 0 | 0 | 0 | 0 | 1 | 0 |
| Halox 1120F | | 0 | 0 | 0 | 0 | 0 | 1 |
| Dragonite XR | | 0 | 0 | 0 | 0 | 0 | 0 |
| Dragonite HP | | 0 | 0 | 0 | 0 | 0 | 0 |
| Bromine | | 19.0 | 19.0 | 19.0 | 19.0 | 19.0 | 19.0 |
| UL-94, 3.2 mm | rating | V-0 | V-0 | V-0 | V-0 | V-0 | V-0 |
| | time, s | 18.17 | 15.38 | 28.69 | 12.78 | 29.65 | 11.93 |
| Afterglow for 3.2 mm, s | | 35 | 0 | 14 | 0 | 7 | 0 |
| UL-94, 1.6 mm | rating | V-0 | V-1 | V-1 | V-1 | V-0 | V-1 |
| | time, s | 9.12 | 9.54 | 9.71 | 12.14 | 14.16 | 8.03 |

| | | | | | | |
|---|---|---|---|---|---|---|
| Afterglow for 1.6 mm, s | 85 | 186 | 173 | 185 | 124 | 147 |
| Tensile strength, MPa | 16 | 16 | 16 | 16 | 16 | N/A |
| Tensile modulus, MPa | 1819 | 1833 | 1867 | 1863 | 1830 | 2008 |
| Elongation at yield, % | 1.87 | 1.88 | 1.86 | 1.92 | 1.9 | N/A |
| Elongation at break, % | 7.16 | 6.35 | 4.48 | 4.85 | 6.3 | 2.56 |
| Izod Impact-notched, | 5.87 | 5.07 | 4.66 | 4.69 | 4.81 | 4.29 |
| kJ/m² | | | | | | |

### EXAMPLE 12

Several samples containing a polypropylene impact copolymer and a brominated anionic polystyrene having a number average molecular weight (Mₙ) of about 2708 and 72.9 wt % bromine were prepared and subjected to the UL-94 vertical burn test. Amounts of the components and the flammability test results, along with some additional properties of these samples, are listed in Table 12.

TABLE 12

| | | Run | | | | | | | | | |
|---|---|---|---|---|---|---|---|---|---|---|---|
| | | A | B | C | D | E | F | G | H | I | J |
| Impact copolymer | | 32.62 | 31.62 | 31.47 | 31.22 | 30.97 | 30.97 | 30.97 | 30.97 | 30.97 | 30.72 |
| (Lone Star) | | | | | | | | | | | |
| Br-APS | | 26.10 | 26.10 | 26.10 | 26.10 | 26.10 | 26.10 | 26.10 | 26.10 | 26.10 | 26.10 |
| ATO | | 7.58 | 7.58 | 7.58 | 7.58 | 7.58 | 7.58 | 7.58 | 7.58 | 7.58 | 7.58 |
| Ethaphos 368 | | 0.1 | 0.1 | 0.1 | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 | 0.1 | 0.1 | 0.1 |
| Talc | | 14.0 | 14.0 | 14.0 | 14.0 | 14.0 | 14.0 | 14.0 | 14.0 | 14.0 | 14.0 |
| Melamine | | 1.0 | 1.0 | 1.0 | 1.0 | 1.0 | 1.0 | 1.0 | 1.0 | 1.0 | 1.0 |
| polyphosphate | | | | | | | | | | | |
| Engage 8677 XLT | | 8.0 | 8.0 | 8.0 | 8.0 | 8.0 | 8.0 | 8.0 | 8.0 | 8.0 | 8.0 |
| 5% PTFE in | | 10.0 | 10.0 | 10.0 | 10.0 | 10.0 | 10.0 | 10.0 | 10.0 | 10.0 | 10.0 |
| polypropylene | | | | | | | | | | | |
| Chloro-PE | | 0.5 | 0.5 | 0.5 | 0.5 | 0.5 | 0.5 | 0.5 | 0.5 | 0.5 | 0.5 |
| Ca stearate | | 0 | 0 | 0.15 | 0.15 | 0.15 | 0.15 | 0.15 | 0.15 | 0.15 | 0.15 |
| Hydrotalcite | | 0 | 0 | 0 | 0.25 | 0.50 | 0.50 | 0.50 | 0.50 | 0.50 | 0.50 |
| ADK STAB LA-46 | | 0 | 0.50 | 0.50 | 0.50 | 0.50 | 0.50 | 0.50 | 0.25 | 0.25 | 0.25 |
| ADK STAB LA-31 | | 0 | 0 | 0 | 0 | 0 | 0 | 0 | 0.25 | 0.125 | 0.25 |
| ADK LA-32 | | 0 | 0 | 0 | 0 | 0 | 0 | 0 | 0 | 0.125 | 0 |
| ADK STAB LA-81 | | 0 | 0.50 | 0.50 | 0.50 | 0.50 | 0.00 | 0.00 | 0.50 | 0.50 | 0.25 |
| ADK LA-63P | | 0 | 0 | 0 | 0 | 0 | 0.50 | 0.00 | 0.00 | 0.00 | 0.25 |
| ADK LA77 | | 0 | 0 | 0 | 0 | 0 | 0 | 0.50 | 0.00 | 0.00 | 0.25 |
| Bromine | | 19.0 | 19.0 | 19.0 | 19.0 | 19.0 | 19.0 | 19.0 | 19.0 | 19.0 | 19.0 |
| UL-94, 3.2 mm | rating | V-0 | V-0 | V-0 | V-0 | V-0 | V-0 | V-0 | V-0 | V-0 | V-0 |
| | time, s | 22.18 | 12.22 | 14.44 | 7.49 | 8.07 | 7.73 | 7.33 | 7.26 | 9.38 | 9.21 |
| Afterglow for 3.2 mm, s | | 6 | 0 | 3 | 0 | 8 | 2 | 6 | 0 | 22 | 9 |
| UL-94, 1.6 mm | rating | V-0 | V-1 | V-1 | V-1 | V-1 | V-1 | V-1 | V-1 | V-1 | V-1 |
| | time, s | 13.63 | 7.73 | 7.43 | 8.6 | 7.72 | 7.17 | 7.23 | 7.44 | 7.63 | 7.09 |

| | | | | | | | | | | |
|---|---|---|---|---|---|---|---|---|---|---|
| Afterglow for 1.6 mm, s | 93 | 127 | 169 | 170 | 174 | 182 | 156 | 167 | 162 | 180 |
| Tensile strength, MPa | NA | NA | NA | 16 | 16 | NA | NA | NA | NA | NA |
| Tensile modulus, MPa | 1885 | 1837 | 1889 | 2000 | 2094 | 2134 | 2077 | 2028 | 2035 | 2005 |
| Elongation at yield, % | NA | NA | NA | 1.71 | 1.69 | NA | NA | NA | NA | NA |
| Elongation at break, % | 4.19 | 4.5 | 4.02 | 6.93 | 7.12 | 4.04 | 4.93 | 5.48 | 4.94 | 4.09 |
| Izod Impact-notched, | 4.5 | 5.5 | 8.82 | 9.2 | 9.75 | 7.37 | 8.21 | 9.57 | 9.3 | 8.24 |
| kJ/m² | | | | | | | | | | |

### EXAMPLE 13

Several samples containing a polypropylene impact copolymer and a brominated anionic polystyrene having a number average molecular weight (Mₙ) of about 2714 and 72.8 wt % bromine were prepared and subjected to the UL-94 vertical burn test. Amounts of the components and the flammability test results are listed in Table 13.

TABLE 13

| | | Run | | | | | | | | |
|---|---|---|---|---|---|---|---|---|---|---|
| | | A | B | C | D | E | F | G | H-A | I |
| Impact copolymer (Lone | | 32.6 | 32.5 | 32.4 | 32.1 | 32.0 | 29.2 | 25.9 | 31.1 | 28.1 |
| Star; MFI = 17) | | | | | | | | | | |
| Br-APS | | 26.10 | 26.10 | 26.10 | 26.10 | 26.10 | 26.10 | 26.10 | 26.10 | 26.10 |
| ATO | | 7.6 | 7.6 | 7.6 | 7.6 | 7.6 | 8.0 | 8.2 | 7.6 | 7.6 |
| Ethaphos 368 | | 0.1 | 0.1 | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 | 0.1 | 0.1 |
| Talc | | 14 | 14 | 14 | 14 | 14 | 14 | 0 | 14 | 14 |
| Melamine polyphosphate | | 1 | 1 | 1 | 1 | 1 | 1 | 1 | 0 | 3 |
| ADK STAB LA-46 | | 0 | 0 | 0 | 0 | 0 | 0.5 | 0 | 0 | 0 |
| ADK STAB LA-81 | | 0 | 0 | 0 | 0 | 0 | 0.5 | 0 | 0 | 0 |
| Engage 8677 XLT | | 8.0 | 8.0 | 8.0 | 8.0 | 8.0 | 8.0 | 8.0 | 8.0 | 8.0 |
| Polybond 3200 | | 0 | 0 | 0 | 0 | 0 | 0 | 2 | 0 | 0 |
| 5% PTFE in | | 10.0 | 10.0 | 10.0 | 10.0 | 10.0 | 10.0 | 10.0 | 10.0 | 10.0 |
| polypropylene | | | | | | | | | | |
| Chloro-PE | | 0.5 | 0.5 | 0.5 | 0.5 | 0.5 | 0.5 | 0.5 | 0.5 | 0.5 |
| Ca stearate | | 0 | 0.15 | 0 | 0 | 0.15 | 0.15 | 0 | 0 | 0 |
| TiO₂ | | 0 | 0 | 0 | 0 | 0 | 0 | 0 | 2.5 | 2.5 |
| Hydrotalcite | | 0 | 0 | 0.25 | 0.5 | 0.5 | 0.5 | 0 | 0 | 0 |
| Glass fibers (HP 3299) | | 0 | 0 | 0 | 0 | 0 | 0 | 16 | 0 | 0 |
| Bromine | | 19.0 | 19.0 | 19.0 | 19.0 | 19.0 | 20 | 20.5 | 19.0 | 19.0 |
| UL-94, 3.2 mm | rating | V-0 | V-0 | V-0 | V-0 | V-0 | V-0 | V-1 | V-0 | V-0 |
| | time, s | 9.51 | 8.11 | 9.17 | 13.48 | 7.91 | 8.34 | 69.31 | 9.76 | 7.57 |
| Afterglow for 3.2 mm, s | | 0 | 0 | 0 | 0 | 0 | 2 | 5 | 0 | 0 |
| UL-94, 1.6 mm | rating | V-0 | V-0 | V-0 | V-0 | V-0 | V-1 | V-0 | V-1 | V-0 |
| | time, s | 8.42 | 6.84 | 7.92 | 7.1 | 7.7 | 7.48 | 43.1 | 7.55 | 7.18 |

| | | | | | | | | | |
|---|---|---|---|---|---|---|---|---|---|
| Afterglow for 1.6 mm, s | 80 | 92 | 107 | 104 | 103 | 156 | 53 | 158 | 79 |
| Tensile strength, MPa | 16 | NA | 16 | 16 | 17 | NA | 28 | 16 | NA |
| Tensile modulus, MPa | 1747 | 1840 | 1929 | 1995 | 2151 | 2130 | 4291 | 1905 | 1865 |
| Elongation at yield, % | 1.87 | NA | 1.85 | 1.8 | 1.68 | NA | 2.25 | 1.72 | NA |
| Elongation at break, % | 7.08 | 5.30 | 8.04 | 5.47 | 5.14 | 4.42 | 5.17 | 5.53 | 3.55 |
| Izod Impact-notched, | 5.45 | 5.28 | 5.69 | 5.93 | 7.03 | 8.26 | 9.63 | 6.37 | 4.52 |
| kJ/m² | | | | | | | | | |

### EXAMPLE 14

Several samples containing a polypropylene impact copolymer and a brominated anionic polystyrene having a number average molecular weight (Mₙ) of about 2708 and 72.9 wt % bromine were prepared and subjected to the UL-94 vertical burn test. Amounts of the components and the flammability test results, along with some additional properties of these samples, are listed in Table 14.

TABLE 14

| | | Run | | | | |
|---|---|---|---|---|---|---|
| | | A | B-A | C-A | D-A | E |
| Impact copolymer | | 28.6 | 29.6 | 32.6 | 31.1 | 28.1 |
| (Lone Star) | | | | | | |
| Br-APS | | 26.1 | 26.1 | 26.1 | 26.1 | 26.1 |
| ATO | | 7.6 | 7.6 | 7.6 | 7.6 | 7.6 |
| Ethaphos 368 | | 0.1 | 0.1 | 0.1 | 0.1 | 0.1 |
| Ethanox 310 | | 0.1 | 0.1 | 0.1 | 0.1 | 0.1 |
| Talc | | 0 | 0 | 14.0 | 14.0 | 14.0 |
| Melamine polyphosphate | | 0 | 0 | 0.0 | 0.0 | 0.0 |
| Exolit OP 1312 | | 1 | 0 | 0 | 0 | 3 |
| Engage 8677 XLT | | 8.0 | 8.0 | 8.0 | 8.0 | 8.0 |
| 5% PTFE in | | 10.0 | 10.0 | 10.0 | 10.0 | 10.0 |
| polypropylene | | | | | | |
| Chloro-PE | | 0.5 | 0.5 | 0.5 | 0.5 | 0.5 |
| Surlyn 8920 | | 0 | 0 | 1 | 0 | 0 |
| Glass fibers (HP 3299) | | 16 | 16 | 0 | 0 | 0 |
| Polybond 3200 | | 2 | 2 | 0 | 0 | 0 |
| Bromine | | 19.0 | 19.0 | 19.0 | 19.0 | 19.0 |
| UL-94, 3.2 mm | rating | V-1 | V-1 | V-0 | V-0 | V-0 |
| | time, s | 74 | 78.84 | 7.22 | 6.47 | 6.74 |
| Afterglow for 3.2 mm, s | | 46 | 44 | 61 | 0 | 0 |
| UL-94, 1.6 mm | rating | V-1 | V-1 | V-1 | V-1 | V-0 |
| | time, s | 67.19 | 69.56 | 12.24 | 7.95 | 6.97 |

| | | | | | |
|---|---|---|---|---|---|
| Afterglow for 1.6 mm, s | 55 | 122 | 138 | 206 | 77 |
| Tensile strength, MPa | 30 | 30 | 17 | 15 | NA |
| Tensile modulus, MPa | 3990 | 3789 | 1948 | 1888 | 2089 |
| Elongation at yield, % | 2.36 | 2.46 | 1.91 | 1.72 | NA |
| Elongation at break, % | 5.31 | 5.22 | 10.68 | 7.45 | 2.91 |
| Izod Impact-notched, | 10.18 | 10.6 | 5.10 | 6.43 | 3.12 |
| kJ/m² | | | | | |

### EXAMPLE 15

Several samples containing a polypropylene impact copolymer and a brominated anionic polystyrene (Br-APS) were prepared and subjected to the UL-94 vertical burn test. Most of the samples contained Br-APS having a number average molecular weight (Mₙ) of about 2112 and 73.3 wt % bromine; the samples in Run A-A contained Br-APS with an Mₙ of about 2560 and 74.9 wt % bromine. Amounts of the components and the flammability test results are listed in Table 15.

TABLE 15

| | | Run | | | | | |
|---|---|---|---|---|---|---|---|
| | | A-A | B-A | C | D-A | E | F-A |
| Impact copolymer | | 51.4 | 31.0 | 48.0 | 48.0 | 50.0 | 46.0 |
| (PP7033N) | | | | | | | |
| Br-APS | | 25.4 | 25.8 | 25.8 | 25.8 | 25.8 | 25.8 |
| Ethaphos 368 | | 0.1 | 0.1 | 0.1 | 0.1 | 0.1 | 0.1 |
| Ethanox 310 | | 0.1 | 0.1 | 0.1 | 0.1 | 0.1 | 0.1 |
| ATO | | 9.0 | 9.0 | 9.0 | 9.0 | 9.0 | 9.0 |
| Talc | | 14.0 | 14.0 | 14.0 | 14.0 | 14.0 | 14.0 |
| Melamine polyphosphate | | 0 | 0 | 0 | 0 | 1 | 0 |
| MCA PPM Triazine HF | | 0 | 0 | 3 | 0 | 0 | 0 |
| 5% PTFE in | | 0.0 | 20.0 | 0.0 | 0.0 | 0.0 | 0.0 |
| polypropylene | | | | | | | |
| Zinc borate | | 0 | 0 | 0 | 3 | 0 | 0 |
| Mg(OH)₂ | | 0.0 | 0.0 | 0.0 | 0.0 | 0.0 | 5.0 |
| Bromine | | 19.0 | 19.0 | 19.0 | 19.0 | 19.0 | 19.0 |
| UL-94, 3.2 mm | rating | V-0 | V-0 | V-0 | V-1 | V-0 | V-1 |
| | time, s | 18 | 6 | 12 | 48 | 10 | 71 |
| Afterglow for 3.2 mm, s | | 89 | 34 | 0 | 32 | 0 | 75 |
| UL-94, 1.6 mm | rating | V-1 | V-1 | V-1 | V-0 | V-0 | V-2 |
| | time, s | 31 | 31 | 33 | 37 | 18 | 102 |

| | | | | | | |
|---|---|---|---|---|---|---|
| Afterglow for 1.6 mm, s | 169 | 147 | 140 | 73 | 53 | 110 |

### EXAMPLE 16

Several samples containing a polypropylene impact copolymer and a brominated anionic polystyrene having a number average molecular weight (Mₙ) of about 2714 and 72.8 wt % bromine were prepared and subjected to the UL-94 vertical burn test. Amounts of the components and the flammability test results are listed in Table 16. In Run A, some pigments were included in the composition to determine their effect on afterglow time because it was expected that the pigments might increase the afterglow time; it was observed that the pigments did not appear to affect afterglow time.

TABLE 16

| | | Run | | | | | |
|---|---|---|---|---|---|---|---|
| | | A | B | C-A | D-A | E-A | F |
| Impact copolymer (Lone | | 28.0 | 29.6 | 32.6 | 32.6 | 31.6 | 28.6 |
| Star; MFI = 17) | | | | | | | |
| Br-APS | | 26.1 | 26.1 | 26.1 | 26.1 | 26.1 | 26.1 |
| ATO | | 7.6 | 7.6 | 7.6 | 7.6 | 7.6 | 7.6 |
| Ethaphos 368 | | 0.1 | 0.1 | 0.1 | 0.1 | 0.1 | 0.1 |
| Ethanox 310 | | 0.1 | 0.1 | 0.1 | 0.1 | 0.1 | 0.1 |
| Talc | | 14.0 | 14.0 | 14.0 | 14.0 | 14.0 | 14.0 |
| Exolit OP 1312 | | 3 | 3 | 0 | 0 | 0 | 3 |
| Engage 8677 XLT | | 8.0 | 8.0 | 8.0 | 8.0 | 8.0 | 8.0 |
| 5% PTFE in polypropylene | | 10 | 10 | 10 | 10 | 10 | 10 |
| Chloro-PE | | 0.5 | 0.5 | 0.5 | 0.5 | 0.5 | 0.5 |
| SnO₂ | | 0 | 1 | 0 | 0 | 0 | 0 |
| TiO₂ | | 2.5 | 0 | 0 | 0 | 0 | 0 |
| Al phosphinate | | 0 | 0 | 1 | 0 | 0 | 0 |
| Ca phosphinate | | 0 | 0 | 0 | 1 | 0 | 0 |
| Sicotan Yellow K 2001 FG | | 0.051 | 0 | 0 | 0 | 0 | 0 |
| Sicotan Yellow L 1010 | | 0.032 | 0 | 0 | 0 | 0 | 0 |
| Microlen Black 0068 | | 0.0134 | 0 | 0 | 0 | 2 | 2 |
| Oracet Yellow 180 | | 0.02 | 0 | 0 | 0 | 0 | 0 |
| Bromine | | 19.0 | 19.0 | 19.0 | 19.0 | 19.0 | 19.0 |
| UL-94, 3.2 mm | rating | V-0 | V-0 | V-0 | V-0 | V-0 | V-0 |
| | time, s | 6.24 | 6.91 | 6.8 | 12.38 | 11.73 | 9.01 |
| Afterglow for 3.2 mm, s | | 0 | 0 | 0 | 5 | 93 | 0 |
| UL-94, 1.6 mm | rating | V-0 | V-0 | V-0 | V-1 | fail | V-1 |
| | time, s | 7.7 | 6.94 | 9.06 | 8.15 | 7.96 | 9.12 |

| | | | | | | |
|---|---|---|---|---|---|---|
| Afterglow for 1.6 mm, s | 76 | 63 | 84 | 131 | 421 | 146 |
| Tensile strength, MPa | NA | NA | 16 | 16 | 15 | 15 |
| Tensile modulus, MPa | 2095 | 1976 | 1811 | 1929 | 1820 | 1878 |
| Elongation at yield, % | NA | NA | 1.88 | 1.74 | 1.74 | 1.67 |
| Elongation at break, % | 2.56 | 5.24 | 12.55 | 8.29 | 5.07 | 8.36 |
| Izod Impact-notched, kJ/m² | 3.78 | 4.36 | 6.01 | 5.26 | 4.35 | 3.22 |

### EXAMPLE 17

Several samples containing a polypropylene impact copolymer and a brominated anionic polystyrene having a number average molecular weight (Mₙ) of about 2708 and 72.9 wt % bromine were prepared and subjected to the UL-94 vertical burn test. Amounts of the components and the flammability test results are listed in Table 17.

TABLE 17

| | | Run | | | | | | | |
|---|---|---|---|---|---|---|---|---|---|
| | | A | B | C | D | E | F | G | H-A |
| Impact copolymer (Lone | | 26.6 | 21.6 | 31.6 | 31.6 | 31.6 | 28.9 | 51.1 | 32.6 |
| Star; MFI = 17) | | | | | | | | | |
| Br-APS | | 26.10 | 26.10 | 26.10 | 26.10 | 26.10 | 26.10 | 26.10 | 26.10 |
| ATO | | 7.6 | 7.6 | 7.6 | 7.6 | 7.6 | 7.6 | 7.6 | 7.6 |
| Ethaphos 368 | | 0.1 | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 | 0.1 |
| Talc | | 20 | 25 | 0 | 0 | 0 | 14 | 14 | 14 |
| Melamine | | 1.0 | 1.0 | 1.0 | 1.0 | 1.0 | 1.0 | 1.0 | 0 |
| polyphosphate | | | | | | | | | |
| Engage 8677 XLT | | 8.0 | 8.0 | 8.0 | 8.0 | 8.0 | 8.0 | 8.0 | 8.0 |
| 5% PTFE in | | 10.0 | 10.0 | 10.0 | 10.0 | 10.0 | 10.0 | 0 | 10.0 |
| polypropylene | | | | | | | | | |
| Chloro-PE | | 0.5 | 0.5 | 0.5 | 0.5 | 0.5 | 0.5 | 0 | 0.5 |
| α-Zr phosphate | | 0 | 0 | 15 | 5 | 0 | 0 | 0 | 0 |
| TiO₂ | | 0 | 0 | 0 | 0 | 0 | 3.8 | 0 | 0 |
| SnO₂ | | 0 | 0 | 0 | 0 | 0 | 0 | 0 | 1 |
| Burgess KE | | 0 | 0 | 0 | 10 | .5 | 0 | 0 | 0 |
| Bromine | | 19.0 | 19.0 | 19.0 | 19.0 | 19.0 | 19.0 | 19.0 | 19.0 |
| UL-94, 3.2 mm | rating | V-0 | V-0 | V-0 | V-0 | V-0 | V-0 | V-0 | V-0 |
| | time, s | 22.18 | 12.22 | 14.44 | 7.49 | 8.07 | 7.73 | 7.33 | 7.26 |
| Afterglow for 3.2 mm, s | | 6 | 0 | 3 | 0 | 8 | 2 | 6 | 0 |
| UL-94, 1.6 mm | rating | V-0 | V-1 | V-1 | V-1 | V-1 | V-1 | V-1 | V-1 |
| | time, s | 13.63 | 7.73 | 7.43 | 8.6 | 7.72 | 7.17 | 7.23 | 7.44 |

| | | | | | | | | |
|---|---|---|---|---|---|---|---|---|
| Afterglow for 1.6 mm, s | 93 | 127 | 169 | 170 | 174 | 182 | 156 | 167 |
| Tensile strength, MPa | NA | NA | NA | 16 | 16 | NA | NA | NA |
| Tensile modulus, MPa | 1885 | 1837 | 1889 | 2000 | 2094 | 2134 | 2077 | 2028 |
| Elongation at yield, % | NA | NA | NA | 1.71 | 1.69 | NA | NA | NA |
| Elongation at break, % | 4.19 | 4.5 | 4.02 | 6.93 | 7.12 | 4.04 | 4.93 | 5.48 |
| Izod Impact-notched, | 4.5 | 5.5 | 8.82 | 9.2 | 9.75 | 7.37 | 8.21 | 9.57 |
| kJ/m² | | | | | | | | |

### EXAMPLE 18

Several samples containing a polypropylene impact copolymer and a brominated anionic polystyrene were prepared and subjected to the UL-94 vertical burn test. Most of the samples contained Br-APS having a number average molecular weight (Mₙ) of about 2560 and 74.9 wt % bromine; the samples in Run G-A contained Br-APS with an Mₙ of about 2714 and 72.8 wt % bromine. Amounts of the components and the flammability test results are listed in Table 18.

TABLE 18

| | | Run | | | | | | |
|---|---|---|---|---|---|---|---|---|
| | | A-A | B-A | C-A | D-A | E-A | F-A | G-A |
| Impact copolymer | | 51.4 | 50.4 | 49.4 | 50.1 | 49.1 | 48.1 | 0 |
| (PP7033N) | | | | | | | | |
| Impact copolymer (Lone | | 0 | 0 | 0 | 0 | 0 | 0 | 33.6 |
| Star; MFI = 17) | | | | | | | | |
| Br-APS | | 25.4 | 25.4 | 25.4 | 26.7 | 26.7 | 26.7 | 26.10 |
| Ethanox 310 | | 0.1 | 0.1 | 0.1 | 0.1 | 0.1 | 0.1 | 0.1 |
| Ethaphos 368 | | 0.1 | 0.1 | 0.1 | 0.1 | 0.1 | 0.1 | 0.1 |
| Talc | | 14.0 | 14.0 | 14.0 | 14.0 | 14.0 | 14.0 | 14 |
| ATO | | 9.0 | 10.0 | 11.0 | 9.0 | 10.0 | 11.0 | 7.6 |
| Engage 8677 XLT | | 0 | 0 | 0 | 0 | 0 | 0 | 8.0 |
| 5% PTFE in polypropylene | | 0 | 0 | 0 | 0 | 0 | 0 | 10.0 |
| Chloro-PE | | 0 | 0 | 0 | 0 | 0 | 0 | 0.5 |
| Bromine | | 19.0 | 19.0 | 19.0 | 20.0 | 20.0 | 20.0 | 19.0 |
| UL-94, 3.2 mm | rating | V-0 | V-0 | V-0 | V-0 | V-0 | V-0 | V-0 |
| | time, s | 18 | 16 | 40 | 14 | 10 | 11 | 13.62 |
| Afterglow for 3.2 mm, s | | 89 | 88 | 90 | 85 | 101 | 112 | 0 |
| UL-94, 1.6 mm | rating | V-1 | V-1 | Fail | V-1 | V-1 | V-1 | V-0 |
| | time, s | 31 | 35 | 40 | 35 | 30 | 28 | 7.33 |

| | | | | | | | |
|---|---|---|---|---|---|---|---|
| Afterglow for 1.6 mm, s | 169 | 169 | 272 | 192 | 217 | 223 | 104 |
| MFI, g/10 min. | 10.58 | 10.69 | 10.61 | 11.48 | 11.11 | 11.01 | — |

### EXAMPLE 19

Several samples containing a polypropylene impact copolymer and a brominated anionic polystyrene having a number average molecular weight (Mₙ) of about 750 and 73 wt % bromine were prepared and subjected to the UL-94 vertical burn test. Amounts of the components and the flammability test results, along with some additional properties of these samples, are listed in Table 19.

TABLE 19

| Run | | A | B | C | D |
|---|---|---|---|---|---|
| Impact copolymer (Lone Star; MFI = 17) | | 32.0 | 25.3 | 32.3 | 28.3 |
| Br-APS | | 26.1 | 30.0 | 32.0 | 30.0 |
| Exolit OP 1312 | | 1 | 12 | 1 | 1 |
| ATO | | 7.6 | 0 | 2.0 | 2.0 |
| Ethaphos 368 | | 0.1 | 0.1 | 0.1 | 0.1 |
| Ethanox 310 | | 0.1 | 0.1 | 0.1 | 0.1 |
| Talc | | 14.0 | 14.0 | 14.0 | 14.0 |
| 5% PTFE in polypropylene | | 10 | 10 | 10 | 10 |
| Chloro-PE | | 0.5 | 0.5 | 0.5 | 0.5 |
| Engage XLT 8677 | | 8.0 | 8.0 | 8.0 | 8.0 |
| Zinc borate | | 0 | 0 | 0 | 6 |
| Calcium stearate | | 0.15 | 0 | 0 | 0 |
| Hydrotalcite | | 0.5 | 0 | 0 | 0 |
| Bromine | | 19 | 21.8 | 23.3 | 23.3 |
| UL-94, 3.2 mm | rating | V-0 | V-0 | V-0 | V-0 |
| | time, s | 15.51 | 25.13 | 26.38 | 17.66 |
| Afterglow for 3.2 mm, s | | 14 | 0 | 0 | 0 |
| UL-94, 1.6 mm | rating | V-0 | V-1 | V-0 | V-0 |
| | time, s | 10.79 | 64.32 | 38.20 | 16.76 |

| | | | | |
|---|---|---|---|---|
| Afterglow for 1.6 mm, s | 69 | 0 | 0 | 2 |
| Tensile modulus, MPa | 2240 | 2559 | 2197 | 2225 |
| Elongation at break, % | 3.46 | 2.64 | 4.49 | 3.94 |
| Izod Impact-notched, kJ/m² | 7.28 | 2.71 | 5.00 | 5.11 |

### EXAMPLE 20

Several samples containing a polypropylene impact copolymer and a brominated anionic polystyrene having a number average molecular weight (Mₙ) of about 750 and 73 wt % bromine were prepared and subjected to the UL-94 vertical burn test. Amounts of the components and the flammability test results, along with some additional properties of these samples, are listed in Table 20. Runs A-C are comparative for the glow suppressant containing embodiments.

TABLE 20

| | | Run | | | | |
|---|---|---|---|---|---|---|
| | | A-A | B-A | C-A | D | E |
| Impact copolymer (Lone | | 78.7 | 85.85 | 65.7 | 23.3 | 32.4 |
| Star; MFI = 17) | | | | | | |
| Br-APS | | 10 | 10 | 9 | 30.2 | 34 |
| Melamine polyphosphate | | 0 | 0 | 0 | 0 | 3 |
| Exolit OP 1312 | | 0 | 0 | 0 | 1 | 2 |
| ATO | | 3.3 | 3.3 | 3.3 | 8.8 | 9.9 |
| Ethaphos 368 | | 0.1 | 0.1 | 0.1 | 0.1 | 0.1 |
| Ethanox 310 | | 0.1 | 0.1 | 0.1 | 0.1 | 0.1 |
| Talc | | 0 | 0 | 14.0 | 0 | 0 |
| 5% PTFE in | | 0 | 0 | 0 | 10 | 10 |
| polypropylene | | | | | | |
| Chloro-PE | | 0 | 0 | 0 | 0.5 | 0.5 |
| Engage XLT 8677 | | 8.0 | 0 | 8.0 | 8.0 | 8.0 |
| Calcium stearate | | 0 | 0.15 | 0 | 0 | 0 |
| Hydrotalcite | | 0 | 0.5 | 0 | 0 | 0 |
| Polybond 3200 | | 0 | 0 | 0 | 2 | 0 |
| Fiberglass strands | | 0 | 0 | 0 | 16 | 0 |
| Bromine | | 6.6 | 6.6 | 19 | 22 | 24.8 |
| UL-94, 3.2 mm | rating | V-2 | V-2 | V-2 | V-0 | V-0 |
| | time, s | 51.72 | 57.63 | 146.8 | 17.47 | 32.81 |
| Afterglow for 3.2 mm, s | | 0 | 0 | 0 | 0 | 12 |
| UL-94, 1.6 mm | rating | Fail | Fail | Fail | V-0 | V-0 |
| | time, s | 141.73 | 120.16 | 153.93 | 17.34 | 10.48 |

| | | | | | |
|---|---|---|---|---|---|
| Afterglow for 1.6 mm, s | 0 | 0 | 0 | 33 | 0 |
| Tensile strength, MPa | 17 | 19 | 17 | — | 17 |
| Tensile modulus, MPa | 1237 | 1468 | 1713 | 5652 | 1973 |
| Elongation at yield, % | 3.36 | 3.27 | 2.74 | — | 1.45 |
| Elongation at break, % | 24.26 | 48.29 | 11.92 | 3.04 | 4.80 |
| Izod Impact-notched, | 49.29 | 9.23 | 8.59 | 12.6 | 5.53 |
| kJ/m² | | | | | |

### EXAMPLE 21

Samples containing LLDPE, LDPE, HDPE, or a polypropylene impact copolymer, and a brominated anionic polystyrene having a number average molecular weight (Mₙ) of about 750 and 73 wt % bromine were prepared and subjected to the UL-94 vertical burn test. Amounts of the components and the flammability test results, along with some additional properties of these samples, are listed in Table 20. Runs A, C, and E are comparative for the glow suppressant containing embodiments.

TABLE 21

| | | Run | | | | | | | |
|---|---|---|---|---|---|---|---|---|---|
| | | A-A | B | C-A | D | E-A | F | G | H |
| LLDPE (Petrothene GA | | 33.62 | 32.62 | 0 | 0 | 0 | 0 | 0 | 0 |
| 564189) | | | | | | | | | |
| Impact copolymer (Lone | | 0 | 0 | 0 | 0 | 0 | 0 | 34.0 | 30.8 |
| Star; MFI = 17) | | | | | | | | | |
| LDPE (Lone Star 220) | | 0 | 0 | 33.6 | 32.6 | 0 | 0 | 0 | 0 |
| HDPE (Alathon | | 0 | 0 | 0 | 0 | 33.6 | 32.6 | 0 | 0 |
| LR590005) | | | | | | | | | |
| Br-APS | | 26.1 | 26.1 | 26.1 | 26.1 | 26.1 | 26.1 | 13.1 | 13.1 |
| Saytex 8010 | | 0 | 0 | 0 | 0 | 0 | 0 | 11.6 | 0 |
| BT-93W | | 0 | 0 | 0 | 0 | 0 | 0 | 0 | 14.2 |
| Melamine polyphosphate | | 0 | 1 | 0 | 1 | 0 | 1 | 1 | 1 |
| ATO | | 7.6 | 7.6 | 7.6 | 7.6 | 7.6 | 7.6 | 7.6 | 7.6 |
| Ethaphos 368 | | 0.1 | 0.1 | 0.1 | 0.1 | 0.1 | 0.1 | 0.1 | 0.1 |
| Ethanox 310 | | 0.1 | 0.1 | 0.1 | 0.1 | 0.1 | 0.1 | 0.1 | 0.1 |
| Talc | | 14 | 14 | 14 | 14 | 14 | 14 | 14 | 14 |
| 5% PTFE in LLDPE | | 10 | 10 | 0 | 0 | 0 | 0 | 0 | 0 |
| 5% PTFE in LDPE | | 0 | 0 | 10 | 10 | 0 | 0 | 0 | 0 |
| 5% PTFE in HDPE | | 0 | 0 | 0 | 0 | 10 | 10 | 0 | 0 |
| 5% PTFE in | | 0 | 0 | 0 | 0 | 0 | 0 | 10 | 10 |
| polypropylene | | | | | | | | | |
| Chloro-PE | | 0.5 | 0.5 | 0.5 | 0.5 | 0.5 | 0.5 | 0.5 | 0.5 |
| Engage XLT 8677 | | 8 | 8 | 8 | 8 | 8 | 8 | 8 | 8 |
| Calcium stearate | | 0 | 0 | 0 | 0 | 0 | 0 | 0 | 0.15 |
| Hydrotalcite | | 0 | 0 | 0 | 0 | 0 | 0 | 0 | 0.5 |
| Bromine | | 19 | 19 | 19 | 19 | 19 | 19 | 19 | 19 |
| UL-94, 3.2 mm | rating | V-0 | V-0 | V-0 | V-0 | V-0 | V-0 | V-0 | V-0 |
| | time, s | 7.17 | 9.11 | 7.29 | 7.93 | 7.48 | 7.00 | 12.23 | 7.78 |
| Afterglow for 3.2 mm, s | | 21 | 15 | 0 | 2 | 14 | 2 | 16 | 31 |
| UL-94, 1.6 mm | rating | V-0 | V-0 | V-1 | V-0 | V-0 | V-0 | V-0 | V-1 |
| | time, s | 8.79 | 8.79 | 27.97 | 8.82 | 9.92 | 7.17 | 7.58 | 7.48 |

| | | | | | | | | |
|---|---|---|---|---|---|---|---|---|
| Afterglow for 1.6 mm, s | 3 | 3 | 4 | 2 | 6 | 4 | 29 | 151 |
| Tensile strength, MPa | 11 | 10 | 12 | 11 | 19 | 20 | 16 | 16 |
| Tensile modulus, MPa | 915 | 900 | 946 | 900 | 1902 | 1936 | 1762 | 1982 |
| Elongation at yield, % | 5.69 | 5.6 | 9.83 | 8.42 | 4.49 | 4.4 | 2.33 | 1.83 |
| Elongation at break, % | 14.88 | 12.12 | 67.79 | 49.60 | 26.15 | 22.01 | 16.63 | 7.54 |
| Izod Impact-notched, | 6.032 | 5.102 | 19.04 | 15.44 | 8.032 | 7.488 | 5.763 | 8.014 |
| kJ/m² | | | | | | | | |

Further embodiments of the invention include, without limitation:
A) A flame retardant additive composition which comprises
   at least one glow suppressant, wherein the glow suppressant is a compound comprising at least one 5-membered or 6-membered ring moiety containing at least one nitrogen atom; and
   at least one brominated flame retardant, wherein the brominated flame retardant contains aromatically-bound bromine and is selected from
      a) a brominated anionic styrenic polymer having a number average molecular weight of about 750 to about 7500, and/or a bromine content of about 60 wt % to about 77 wt %,
      b) a brominated anionic chain transfer vinyl aromatic polymer which contains about 70 wt % or more bromine,
      or a mixture of any two or more of these;
         wherein the flame retardant additive composition contains about 0.5 wt % or more glow suppressant, based on the total weight of the flame retardant additive composition.
B) A flame retardant additive composition as in A) wherein the 5-membered or 6-membered ring moiety containing at least one nitrogen atom of the glow suppressant is an unsaturated ring moiety.
C) A flame retardant additive composition as in A) wherein the 5-membered or 6-membered ring moiety containing at least one nitrogen atom of the glow suppressant is selected from triazole, piperidine, piperazine, triazine, and morpholine.
D) A flame retardant additive composition as in any of A)-C) which contains about 1 wt % or more glow suppressant, based on the total weight of the flame retardant additive composition.
E) A flame retardant additive composition as in A) which comprises at least one inorganic compound.
F) A flame retardant additive composition as in Claim E) wherein the total amount of inorganic compounds is about 10 wt % or more, based on the total weight of the flame retardant additive composition.
G) A flame retardant additive composition as in Claim E) wherein the inorganic compound comprises talc, antimony trioxide, zinc borate, aluminum phosphinate, aluminum diethyl phosphinate, calcium phosphinate, and/or hydrotalcite.
H) A flame retardant additive composition as in Claim E) wherein the inorganic compound comprises talc and antimony trioxide, and optionally at least one inorganic compound selected from zinc borate, aluminum phosphinate, aluminum diethyl phosphinate, calcium phosphinate, and/or hydrotalcite.
I) A flame retardant additive composition as in any of A)-F) wherein the glow suppressant comprises melamine polyphosphate, wherein the composition comprises at least one inorganic compound, and wherein the inorganic compound is zinc borate and aluminum diethyl phosphinate.
J) A flame retardant additive composition as in any of A)-I) wherein the glow suppressant comprises melamine polyphosphate.
K) A flame retardant additive composition as in any of A)-J) wherein the brominated anionic styrenic polymer is a brominated anionic polystyrene having a number average molecular weight of about 1000 to about 4000, and/or a bromine content of about 70 wt % to about 77 wt %.
L) A flame retardant additive composition as in any of A)-J) wherein the brominated anionic styrenic polymer is a brominated anionic polystyrene having a number average molecular weight of about 2000 to about 3500, and/or a bromine content of about 72 wt % to about 76 wt %.
M) A process for forming a flame retardant additive composition, which process comprises combining
   at least one glow suppressant, wherein the glow suppressant is a compound comprising at least one 5-membered or 6-membered ring moiety containing at least one nitrogen atom; and
   at least one brominated flame retardant that contains aromatically-bound bromine and is selected from
      a) a brominated anionic styrenic polymer having a number average molecular weight of about 750 to about 7500, and/or a bromine content of about 60 wt % to about 77 wt %,
      b) a brominated anionic chain transfer vinyl aromatic polymer which contains about 70 wt % or more bromine,
      or a mixture of any two or more of these;
   in amounts such that the flame retardant additive composition contains about 0.5 wt % or more glow suppressant, based on the total weight of the flame retardant additive composition.
N) A process as in M) wherein the 5-membered or 6-membered ring moiety containing at least one nitrogen atom of the glow suppressant is an unsaturated ring moiety.
O) A process as in M) wherein the 5-membered or 6-membered ring moiety containing at least one nitrogen atom of the glow suppressant is selected from triazole, piperidine, piperazine, triazine, and morpholine.
P) A process as in any of M)-0) wherein the glow suppressant is in an amount of about 1 wt % or more, based on the total weight of the flame retardant additive composition.
Q) A process as in M) which comprises combining at least one inorganic compound.
R) A process as in Q) wherein the inorganic compound is in an amount such that the flame retardant additive composition contains about 10 wt % or more inorganic compound, based on the total weight of the flame retardant additive composition.
S) A process as in Q) or R) wherein the inorganic compound comprises talc, antimony trioxide, zinc borate, aluminum phosphinate, aluminum diethyl phosphinate, calcium phosphinate, and/or hydrotalcite.
T) A process as in Q) or R) wherein the inorganic compound comprises talc and antimony trioxide, and optionally at least one inorganic compound selected from zinc borate, aluminum phosphinate, aluminum diethyl phosphinate, calcium phosphinate, and/or hydrotalcite.
U) A process as in any of M)-T) wherein the glow suppressant comprises melamine polyphosphate.
V) A process as in Q) or R) wherein the glow suppressant comprises melamine polyphosphate, wherein the process comprises combining at least one inorganic compound, and wherein the inorganic compounds are zinc borate and aluminum diethyl phosphinate.
W) A process as in any of M)-V) wherein the brominated anionic styrenic polymer is a brominated anionic polystyrene having a number average molecular weight of about 1000 to about 4000, and/or a bromine content of about 70 wt % to about 77 wt %.
X) A process as in any of M)-V) wherein the brominated anionic styrenic polymer is a brominated anionic polystyrene having a number average molecular weight of about 2000 to about 3500, and/or a bromine content of about 72 wt % to about 76 wt %.
Y) A flame retarded polyolefin composition formed from
   i) at least one glow suppressant, wherein the glow suppressant is a compound comprising at least one 5-membered or 6-membered ring moiety containing at least one nitrogen atom;
   ii) at least one inorganic compound; and
   iii) at least one brominated flame retardant in a flame retardant amount, wherein the brominated flame retardant contains aromatically-bound bromine and is selected from
      a) a brominated anionic styrenic polymer having a number average molecular weight of about 750 to about 7500, and/or a bromine content of about 60 wt % to about 77 wt %,
      b) a brominated anionic chain transfer vinyl aromatic polymer which contains about 70 wt % or more bromine,
      or a mixture of any two or more of these, and
   iv) at least one polyolefin,
   wherein the flame retarded polyolefin composition contains about 0.25 wt % or more glow suppressant, based on the total weight of the flame retarded polyolefin composition, and wherein the flame retarded polyolefin composition contains about 5 wt % or more inorganic compound, based on the total weight of the flame retarded polyolefin composition.
Z) A flame retarded polyolefin composition as in Y) wherein the 5-membered or 6-membered ring moiety containing at least one nitrogen atom of the glow suppressant is an unsaturated ring moiety.
AA) A flame retarded polyolefin composition as in Y) wherein the 5-membered or 6-membered ring moiety containing at least one nitrogen atom of the glow suppressant is selected from triazole, piperidine, piperazine, triazine, and morpholine.
AB) A flame retarded polyolefin composition as in any of Y)-AA) which contains about 0.5 wt % or more glow suppressant, based on the total weight of the flame retarded polyolefin composition.
AC) A flame retarded polyolefin composition as in Y) wherein the inorganic compound is in an amount of about 10 wt % or more, based on the total weight of the flame retarded polyolefin composition.
AD) A flame retarded polyolefin composition as in any of Y)-AC) wherein the inorganic compound comprises talc, antimony trioxide, zinc borate, aluminum phosphinate, aluminum diethyl phosphinate, calcium phosphinate, and/or hydrotalcite.
AE) A flame retarded polyolefin composition as in any of Y)-AC) wherein the inorganic compound comprises talc and antimony trioxide, and optionally at least one inorganic compound selected from zinc borate, aluminum phosphinate, aluminum diethyl phosphinate, calcium phosphinate, and/or hydrotalcite.
AF) A flame retarded polyolefin composition as in any of Y)-AE) wherein the glow suppressant comprises melamine polyphosphate.
AG) A flame retarded polyolefin composition as in any of Y)-AC) wherein the glow suppressant comprises melamine polyphosphate, wherein the composition comprises at least one inorganic compound, and wherein the inorganic compound is zinc borate and aluminum diethyl phosphinate.
AH) A flame retarded polyolefin composition as in any of Y)-AG) wherein the brominated anionic styrenic polymer is a brominated anionic polystyrene having a number average molecular weight of about 1000 to about 4000, and/or a bromine content of about 70 wt % to about 77 wt %.
AI) A flame retarded polyolefin composition as in any of Y)-AG) wherein the brominated anionic styrenic polymer is a brominated anionic polystyrene having a number average molecular weight of about 2000 to about 3500, and/or a bromine content of about 72 wt % to about 76 wt %.
AJ) A process for forming a flame retarded polyolefin composition, which process comprises combining
   i) at least one glow suppressant, wherein the glow suppressant is a compound comprising at least one 5-membered or 6-membered ring moiety containing at least one nitrogen atom;
   ii) at least one inorganic compound;
   iii) at least one brominated flame retardant in a flame retardant amount, wherein the brominated flame retardant contains aromatically-bound bromine and is selected from
      a) a brominated anionic styrenic polymer having a number average molecular weight of about 750 to about 7500, and/or a bromine content of about 60 wt % to about 77 wt %,
      b) a brominated anionic chain transfer vinyl aromatic polymer which contains about 70 wt % or more bromine,
      or a mixture of any two or more of these, and
   iv) at least one polyolefin,
   in amounts such that the flame retarded polyolefin composition contains about 0.25 wt % or more glow suppressant, based on the total weight of the flame retarded polyolefin composition, and wherein the flame retarded polyolefin composition contains about 5 wt % or more inorganic compound, based on the total weight of the flame retarded polyolefin composition.
AK) A process as in AJ) wherein the 5-membered or 6-membered ring moiety containing at least one nitrogen atom of the glow suppressant is an unsaturated ring moiety.
AL) A process as in AJ) wherein the 5-membered or 6-membered ring moiety containing at least one nitrogen atom of the glow suppressant is selected from triazole, piperidine, piperazine, triazine, and morpholine.
AM) A process as in any of AJ)-AL) which contains about 0.5 wt % or more glow suppressant, based on the total weight of the flame retarded polyolefin composition.
AN) A process as in AJ) wherein the inorganic compound is in an amount such that the flame retarded polyolefin composition contains about 10 wt % or more inorganic compound, based on the total weight of the flame retarded polyolefin composition.
AO) A process as in any of AJ)-AN) wherein the inorganic compound comprises talc, antimony trioxide, zinc borate, aluminum phosphinate, aluminum diethyl phosphinate, calcium phosphinate, and/or hydrotalcite.
AP) A process as in any of AJ)-AN) wherein the inorganic compound comprises talc and antimony trioxide, and optionally at least one inorganic compound selected from zinc borate, aluminum phosphinate, aluminum diethyl phosphinate, calcium phosphinate, and/or hydrotalcite.
AQ) A process as in any of AJ)-AP) wherein the glow suppressant comprises melamine polyphosphate.
AR) A process as in any of AJ)-AM) wherein the glow suppressant comprises melamine polyphosphate, and wherein the inorganic compounds are zinc borate and aluminum diethyl phosphinate.
AS) A process as in any of AJ)-AR) wherein the brominated anionic styrenic polymer is a brominated anionic polystyrene having a number average molecular weight of about 1000 to about 4000, and/or a bromine content of about 70 wt % to about 77 wt %.
AT) A process as in any of AJ)-AR) wherein the brominated anionic styrenic polymer is a brominated anionic polystyrene having a number average molecular weight of about 2000 to about 3500, and/or a bromine content of about 72 wt % to about 76 wt %.
AU) A flame retarded polyolefin composition formed from at least one polyolefin and a flame retardant amount of a brominated flame retardant that contains aromatically-bound bromine and is a brominated anionic styrenic polymer having a number average molecular weight of about 750 to about 7500, and/or a bromine content of about 60 wt % to about 77 wt %.
AV) A flame retarded polyolefin composition as in AU) wherein the flame retardant amount is about 5 wt % or more, based on the total weight of the flame retarded polyolefin composition.
AW) A flame retarded polyolefin composition as in AU) or AV) which comprises at least one inorganic compound.
AX) A flame retarded polyolefin composition as in AW) wherein the inorganic compounds comprise talc, antimony trioxide, zinc borate, aluminum phosphinate, aluminum diethyl phosphinate, calcium phosphinate, and/or hydrotalcite.
AY) A flame retarded polyolefin composition as in AW) wherein the inorganic compounds are talc and antimony trioxide, and at least one inorganic compound selected from zinc borate, aluminum phosphinate, aluminum diethyl phosphinate, calcium phosphinate, and/or hydrotalcite.
AZ) A flame retarded polyolefin composition as in any of AU)-AY) wherein the brominated anionic styrenic polymer is a brominated anionic polystyrene having a number average molecular weight of about 1000 to about 4000, and/or a bromine content of about 70 wt % to about 77 wt %.
BA) A flame retarded polyolefin composition as in any of AU)-AY) wherein the brominated anionic styrenic polymer is a brominated anionic polystyrene having a number average molecular weight of about 2000 to about 3500, and/or a bromine content of about 72 wt % to about 76 wt %.
BB) A masterbatch which comprises
   a polyolefin; and
   a brominated flame retardant that contains aromatically-bound bromine and is selected from
      a) a brominated anionic styrenic polymer having a weight average molecular weight of about 750 to about 7500, and/or a bromine content of about 60 wt % to about 77 wt %,
      b) a brominated anionic chain transfer vinyl aromatic polymer which contains about 70 wt % or more bromine,
      or a mixture of any two or more of these.
BC) A masterbatch as in BB) which comprises at least one glow suppressant, wherein the glow suppressant is a compound comprising at least one 5-membered or 6-membered ring moiety containing at least one nitrogen atom.
BD) A masterbatch as in BB) which comprises at least one inorganic compound and at least one glow suppressant, wherein the glow suppressant is a compound comprising at least one 5-membered or 6-membered ring moiety containing at least one nitrogen atom.
BE) A masterbatch as in BC) or BD) wherein the 5-membered or 6-membered ring moiety containing at least one nitrogen atom of the glow suppressant is an unsaturated ring moiety.
BF) A masterbatch as in BC) or BD) wherein the 5-membered or 6-membered ring moiety containing at least one nitrogen atom of the glow suppressant is selected from triazole, piperidine, piperazine, triazine, and morpholine.
BG) A masterbatch as in BB) which comprises at least one inorganic compound.
BH) A masterbatch as in BD) or BG) wherein the inorganic compound comprises antimony trioxide.
BI) A masterbatch as in any of BB)-BF) wherein the glow suppressant comprises melamine polyphosphate.
BJ) A masterbatch as in BB) wherein the glow suppressant comprises melamine polyphosphate, wherein the masterbatch comprises at least one inorganic compound, and wherein the inorganic compound is antimony trioxde.
BK) A masterbatch as in any of BB)-BJ) wherein the brominated anionic styrenic polymer is a brominated anionic polystyrene having a number average molecular weight of about 1000 to about 4000, and/or a bromine content of about 70 wt % to about 77 wt %.
BL) A masterbatch as in any of BB)-BJ) wherein the brominated anionic styrenic polymer is a brominated anionic polystyrene having a number average molecular weight of about 2000 to about 3500, and/or a bromine content of about 72 wt % to about 76 wt %.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A flame retardant additive composition which comprises
at least one glow suppressant, wherein the glow suppressant is a compound comprising at least one 5-membered or 6-membered ring moiety containing at least one nitrogen atom; and
at least one brominated flame retardant, wherein the brominated flame retardant contains aromatically-bound bromine and is selected from
a) a brominated anionic styrenic polymer having a number average molecular weight of about 750 to about 7500, and/or a bromine content of about 60 wt % to about 77 wt %,
b) a brominated anionic chain transfer vinyl aromatic polymer which contains about 70 wt % or more bromine,
or a mixture of any two or more of these;
wherein the flame retardant additive composition contains about 0.5 wt % or more glow suppressant, based on the total weight of the flame retardant additive composition.

2. A flame retardant additive composition as in claim 1 wherein the 5-membered or 6-membered ring moiety containing at least one nitrogen atom of the glow suppressant is an unsaturated ring moiety, or wherein the 5-membered or 6-membered ring moiety containing at least one nitrogen atom of the glow suppressant is selected from triazole, piperidine, piperazine, triazine, and morpholine.

3. (canceled)

4. A flame retardant additive composition as in claim 1 which contains about 1 wt % or more glow suppressant, based on the total weight of the flame retardant additive composition.

5. A flame retardant additive composition as in claim 1 which comprises at least one inorganic compound, optionally wherein
the total amount of inorganic compounds is about 10 wt % or more, based on the total weight of the flame retardant additive composition; or
ii the inorganic compound comprises talc, antimony trioxide, zinc borate, aluminum phosphinate, aluminum diethyl phosphinate, calcium phosphinate, and/or hydrotalcite; or
iii) the inorganic compound comprises talc and antimony trioxide, and optionally at least one inorganic compound selected from zinc borate, aluminum phosphinate, aluminum diethyl phosphinate, calcium phosphinate, and/or hydrotalcite

6-8. (canceled)

9. A flame retardant additive composition as in claim 1 wherein the glow suppressant comprises melamine polyphosphate, optionally wherein the composition comprises at least one inorganic compound, and wherein the inorganic compound is zinc borate and aluminum diethyl phosphinate.

10. (canceled)

11. A flame retardant additive composition as in claim 1 wherein the brominated anionic styrenic polymer is
i) a brominated anionic polystyrene having a number average molecular weight of about 1000 to about 4000, and/or a bromine content of about 70 wt % to about 77 wt %, or
ii) a brominated anionic polystyrene having a number average molecular weight of about 2000 to about 3500, and/or a bromine content of about 72 wt % to about 76 wt %.

12. (canceled)

13. A process for forming a flame retardant additive composition, which process comprises combining
at least one glow suppressant, wherein the glow suppressant is a compound comprising at least one 5-membered or 6-membered ring moiety containing at least one nitrogen atom; and
at least one brominated flame retardant that contains aromatically-bound bromine and is selected from
a) a brominated anionic styrenic polymer having a number average molecular weight of about 750 to about 7500, and/or a bromine content of about 60 wt % to about 77 wt %,
b) a brominated anionic chain transfer vinyl aromatic polymer which contains about 70 wt % or more bromine,
or a mixture of any two or more of these;
in amounts such that the flame retardant additive composition contains about 0.5 wt % or more glow suppressant, based on the total weight of the flame retardant additive composition.

14. A process as in claim 13 wherein the 5-membered or 6-membered ring moiety containing at least one nitrogen atom of the glow suppressant is an unsaturated ring moiety, or wherein the 5-membered or 6-membered ring moiety containing at least one nitrogen atom of the glow suppressant is selected from triazole, piperidine, piperazine, triazine, and morpholine.

15. (canceled)

16. A process as in claim 13 wherein the glow suppressant is in an amount of about 1 wt % or more, based on the total weight of the flame retardant additive composition.

17. A process as in claim 13 which comprises combining at least one inorganic compound, optionally wherein the inorganic compound is in an amount such that the flame retardant additive composition contains about 10 wt % or more inorganic compound, based on the total weight of the flame retardant additive composition.

18. (canceled)

19. A process as in claim 17 wherein the inorganic compound comprises talc, antimony trioxide, zinc borate, aluminum phosphinate, aluminum diethyl phosphinate, calcium phosphinate, and/or hydrotalcite, or wherein the inorganic compound comprises talc and antimony trioxide, and optionally at least one inorganic compound selected from zinc borate, aluminum phosphinate, aluminum diethyl phosphinate, calcium phosphinate, and/or hydrotalcite.

20. (canceled)

21. A process as in claim 13 wherein the glow suppressant comprises melamine polyphosphate, optionally wherein the process comprises combining at least one inorganic compound, and wherein the inorganic compounds are zinc borate and aluminum diethyl phosphinate.

22. (canceled)

23. A process as in claim 13 wherein the brominated anionic styrenic polymer is
i) a brominated anionic polystyrene having a number average molecular weight of about 1000 to about 4000, and/or a bromine content of about 70 wt % to about 77 wt %, or
ii) a brominated anionic polystyrene having a number average molecular weight of about 2000 to about 3500, and/or a bromine content of about 72 wt % to about 76 wt %.

24. (canceled)

25. A flame retarded polyolefin composition formed from
i) at least one glow suppressant, wherein the glow suppressant is a compound comprising at least one 5-membered or 6-membered ring moiety containing at least one nitrogen atom;
ii) at least one inorganic compound; and
iii) at least one brominated flame retardant in a flame retardant amount, wherein the brominated flame retardant contains aromatically-bound bromine and is selected from
a) a brominated anionic styrenic polymer having a number average molecular weight of about 750 to about 7500, and/or a bromine content of about 60 wt % to about 77 wt %,
b) a brominated anionic chain transfer vinyl aromatic polymer which contains about 70 wt % or more bromine,
or a mixture of any two or more of these, and
iv) at least one polyolefin,
wherein the flame retarded polyolefin composition contains about 0.25 wt % or more glow suppressant, based on the total weight of the flame retarded polyolefin composition, and wherein the flame retarded polyolefin composition contains about 5 wt % or more inorganic compound, based on the total weight of the flame retarded polyolefin composition.

26. A flame retarded polyolefin composition as in claim 25 wherein the 5-membered or 6-membered ring moiety containing at least one nitrogen atom of the glow suppressant is an unsaturated ring moiety, or wherein the 5-membered or 6-membered ring moiety containing at least one nitrogen atom of the glow suppressant is selected from triazole, piperidine, piperazine, triazine, and morpholine.

27. (canceled)

28. A flame retarded polyolefin composition as in claim 25 which contains about 0.5 wt % or more glow suppressant, based on the total weight of the flame retarded polyolefin composition.

29. A flame retarded polyolefin composition as in claim 25 wherein the inorganic compound is in an amount of about 8 wt % or more, based on the total weight of the flame retarded polyolefin composition.

30. A flame retarded polyolefin composition as in claim 25 wherein the inorganic compound comprises talc, antimony trioxide, zinc borate, aluminum phosphinate, aluminum diethyl phosphinate, calcium phosphinate, and/or hydrotalcite, or wherein the inorganic compound comprises talc and antimony trioxide, and optionally at least one inorganic compound selected from zinc borate, aluminum phosphinate, aluminum diethyl phosphinate, calcium phosphinate, and/or hydrotalcite.

31. (canceled)

32. A flame retarded polyolefin composition as in claim 25 wherein the glow suppressant comprises melamine polyphosphate, optionally wherein the composition comprises at least one inorganic compound, and wherein the inorganic compound is zinc borate and aluminum diethyl phosphinate.

33. (canceled)

34. A flame retarded polyolefin composition as in claim 25 wherein the brominated anionic styrenic polymer is
i) a brominated anionic polystyrene having a number average molecular weight of about 1000 to about 4000, and/or a bromine content of about 70 wt % to about 77 wt %, or
ii) a brominated anionic polystyrene having a number average molecular weight of about 2000 to about 3500, and/or a bromine content of about 72 wt % to about 76 wt %.

35. (canceled)

36. A process for forming a flame retarded polyolefin composition, which process comprises combining
i) at least one glow suppressant, wherein the glow suppressant is a compound comprising at least one 5-membered or 6-membered ring moiety containing at least one nitrogen atom;
ii) at least one inorganic compound;
iii) at least one brominated flame retardant in a flame retardant amount, wherein the brominated flame retardant contains aromatically-bound bromine and is selected from
a) a brominated anionic styrenic polymer having a number average molecular weight of about 750 to about 7500, and/or a bromine content of about 60 wt % to about 77 wt %,
b) a brominated anionic chain transfer vinyl aromatic polymer which contains about 70 wt % or more bromine,
or a mixture of any two or more of these, and
iv) at least one polyolefin,
in amounts such that the flame retarded polyolefin composition contains about 0.25 wt % or more glow suppressant, based on the total weight of the flame retarded polyolefin composition, and wherein the flame retarded polyolefin composition contains about 5 wt % or more inorganic compound, based on the total weight of the flame retarded polyolefin composition.

37. A process as in claim 36 wherein the 5-membered or 6-membered ring moiety containing at least one nitrogen atom of the glow suppressant is an unsaturated ring moiety, or wherein the 5-membered or 6-membered ring moiety containing at least one nitrogen atom of the glow suppressant is selected from triazole, piperidine, piperazine, triazine, and morpholine.

38. (canceled)

39. A process as in claim 36 in which there is about 0.5 wt % or more glow suppressant, based on the total weight of the flame retarded polyolefin composition.

40. A process as in claim 36 wherein the inorganic compound is in an amount such that the flame retarded polyolefin composition contains about 8 wt % or more inorganic compound, based on the total weight of the flame retarded polyolefin composition.

41. A process as in claim 36 wherein the inorganic compound comprises talc, antimony trioxide, zinc borate, aluminum phosphinate, aluminum diethyl phosphinate, calcium phosphinate, and/or hydrotalcite, or wherein the inorganic compound comprises talc and antimony trioxide, and optionally at least one inorganic compound selected from zinc borate, aluminum phosphinate, aluminum diethyl phosphinate, calcium phosphinate, and/or hydrotalcite.

42. (canceled)

43. A process as in claim 36 wherein the glow suppressant comprises melamine polyphosphate, optionally wherein the inorganic compounds are zinc borate and aluminum diethyl phosphinate.

44. (canceled)

45. A process as in claim 36 wherein the brominated anionic styrenic polymer is
i) a brominated anionic polystyrene having a number average molecular weight of about 1000 to about 4000, and/or a bromine content of about 70 wt % to about 77 wt %, or
ii) a brominated anionic polystyrene having a number average molecular weight of about 2000 to about 3500, and/or a bromine content of about 72 wt % to about 76 wt %.

46. (canceled)

47. A flame retarded polyolefin composition formed from at least one polyolefin and a flame retardant amount of a brominated flame retardant that contains aromatically-bound bromine and is a brominated anionic styrenic polymer having a number average molecular weight of about 750 to about 7500, and/or a bromine content of about 60 wt % to about 77 wt %.

48. A flame retarded polyolefin composition as in claim 47 wherein the flame retardant amount is about 5 wt % or more, based on the total weight of the flame retarded polyolefin composition.

49. A flame retarded polyolefin composition as in claim 47 which comprises at least one inorganic compound, optionally wherein
the inorganic compounds comprise talc, antimony trioxide, zinc borate, aluminum phosphinate, aluminum diethyl phosphinate, calcium phosphinate, and/or hydrotalcite, or
ii) the inorganic compounds are talc and antimony trioxide, and at least one inorganic compound selected from zinc borate, aluminum phosphinate, aluminum diethyl phosphinate, calcium phosphinate, and/or hydrotalcite.

50-51. (canceled)

52. A flame retarded polyolefin composition as in claim 47 wherein the brominated anionic styrenic polymer is
i) a brominated anionic polystyrene having a number average molecular weight of about 1000 to about 4000, and/or a bromine content of about 70 wt % to about 77 wt %, or
ii) a brominated anionic polystyrene having a number average molecular weight of about 2000 to about 3500, and/or a bromine content of about 72 wt % to about 76 wt %.

53. (canceled)

54. A masterbatch which comprises
a polyolefin; and
a brominated flame retardant that contains aromatically-bound bromine and is selected from
a) a brominated anionic styrenic polymer having a weight average molecular weight of about 750 to about 7500, and/or a bromine content of about 60 wt % to about 77 wt %,
b) a brominated anionic chain transfer vinyl aromatic polymer which contains about 70 wt % or more bromine,
or a mixture of any two or more of these.

55. A masterbatch as in claim 54 which comprises
i) at least one glow suppressant, wherein the glow suppressant is a compound comprising at least one 5-membered or 6-membered ring moiety containing at least one nitrogen atom, or
ii) at least one inorganic compound and at least one glow suppressant, wherein the glow suppressant is a compound comprising at least one 5-membered or 6-membered ring moiety containing at least one nitrogen atom.

56. (canceled)

57. A masterbatch as in claim 55 wherein the 5-membered or 6-membered ring moiety containing at least one nitrogen atom of the glow suppressant is an unsaturated ring moiety, or wherein the 5-membered or 6-membered ring moiety containing at least one nitrogen atom of the glow suppressant is selected from triazole, piperidine, piperazine, triazine, and morpholine.

58. (canceled)

59. A masterbatch as in claim 54 which comprises at least one inorganic compound, optionally wherein the inorganic compound comprises antimony trioxide.

60. (canceled)

61. A masterbatch as in claim 54 wherein the glow suppressant comprises melamine polyphosphate, optionally wherein the masterbatch comprises at least one inorganic compound, and wherein the inorganic compound is antimony trioxde.

62. (canceled)

63. A masterbatch as in claim 54 wherein the brominated anionic styrenic polymer is
i) a brominated anionic polystyrene having a number average molecular weight of about 1000 to about 4000, and/or a bromine content of about 70 wt % to about 77 wt %, or
ii) a brominated anionic polystyrene having a number average molecular weight of about 2000 to about 3500, and/or a bromine content of about 72 wt % to about 76 wt %.

64. (canceled)
